(19) United States
(12) Patent Application Publication
(10) Pub. No.: US 2026/0186648 A1
(43) Pub. Date: Jul. 2, 2026

(54) SHOWCASE

(71) Applicant: Panasonic Intellectual Property Management Co., Ltd., Osaka (JP)

(72) Inventors: Rachaya TAKADA, Tokyo (JP); Takashi TAMURA, Kanagawa (JP); Seiya MIYAZAKI, Hyogo (JP)

(21) Appl. No.: 19/431,414

(22) Filed: Dec. 23, 2025

(30) Foreign Application Priority Data
Dec. 26, 2024 (JP) 2024-230243

(51) Int. Cl. G06F 3/04886; G06F 3/01; G06Q 30/0241; G09F 9/30; G09G 3/20

(52) U.S. Cl. CPC G06F 3/04886; G06Q 30/0241; G09F 9/30; G09G 3/2092; G06F 3/012; G06F 3/013; G09G 2320/06; G09G 2340/0464; G09G 2354/00

(57) ABSTRACT

A showcase capable of storing a product includes: a display screen disposed such that the product is visible; a touch position detection device configured to detect a touch position on the display screen; and a controller configured to display product information related to the product associated with the touch position, in accordance with the touch position.

### TECHNICAL FIELD

The present disclosure relates to a showcase using a transparent display and particularly relates to a showcase that displays information and/or an advertisement on a product based on a touch event by a customer.

### BACKGROUND ART

In related art, a transparent display is adopted for displaying an advertisement and/or information related to a product in a showcase. In Patent Literature (hereinafter, referred to as “PTL”) 1, for example, a technique for displaying an advertisement on a transparent display is known. In PTL 2, a technique for capturing an image of a product by a camera and displaying on a display is disclosed. In the related art, however, a method of directly acquiring by a customer detailed information on a product, using a touch operation, in accordance with a position and/or behavior of the customer is not sufficiently provided.

### CITATION LIST

### Patent Literature

PTL 1: Japanese Patent Application Laid-Open No. 2003-125904
PTL 2: Japanese Registered Utility Model No. 3199688

### SUMMARY OF INVENTION

### Technical Problem

In these techniques, however, there is a problem in that display content of the product and/or advertisement cannot be optimized in accordance with the position and/or behavior of a customer. A technique is not provided, for example, which effectively displays product information and/or advertisement in accordance with interest of a customer and derives and maximizes the attractiveness of the product when a customer approaches a showcase and/or shows interest in the specific product.

The present disclosure has been made in view of such circumstances and thus provides a showcase that can optimize display content of a product and/or advertisement in accordance with a position and/or behavior of a customer.

### Solution to Problem

A showcase of the present disclosure is capable of storing a product, the showcase including: a display screen disposed such that the product is visible; a touch position detection device configured to detect a touch position on the display screen; and a controller configured to display, on the display screen, product information related to the product associated with the touch position, in accordance with the touch position.

### Advantageous Effects of Invention

According to the present invention, it is made possible to optimize display content of a product and/or advertisement in accordance with a position and/or behavior of a customer.

### BRIEF DESCRIPTION OF DRAWINGS

FIG. 1 is a diagram illustrating an overall configuration diagram of a showcase system according to Embodiment 1;

FIG. 2A is a diagram illustrating an “advertisement mode” that is one of display modes;

FIG. 2B is a diagram illustrating a “transmissive mode” that is one of the display modes;

FIG. 3 is a diagram illustrating an example of a display area;

FIG. 4 is a diagram illustrating information used in displaying product information on a screen in response to a touch event;

FIG. 5 is a flowchart illustrating a processing procedure in showcase system 1;

FIG. 6A is a diagram illustrating Variation 1 of Embodiment 1;

FIG. 6B is a diagram illustrating information used when product information is displayed on a screen in accordance with a height of a user according to Variation 1 of Embodiment 1;

FIG. 7 is a flowchart illustrating a processing procedure in Variation 1 of Embodiment 1;

FIG. 8 is a diagram illustrating a parallax that occurs in accordance with a distance between a display and an actual product;

FIG. 9 is a diagram illustrating information used when product information is displayed on a screen by using corrected touch position coordinates according to Variation 2 of Embodiment 1;

FIG. 10 is a flowchart illustrating a processing procedure in Variation 2 of Embodiment 1;

FIG. 11 is a diagram illustrating Variation 3 of Embodiment 1;

FIG. 12 is a flowchart illustrating a processing procedure in Variation 3 of Embodiment 1;

FIG. 13 is a diagram illustrating switching to a mode in Variation 3 of Embodiment 1;

FIG. 14 is a flowchart illustrating a processing procedure in Variation 4 of Embodiment 1;

FIG. 15 is a flowchart illustrating a processing procedure in Variation 5 of Embodiment 1;

FIG. 16 is a flowchart illustrating a processing procedure in Variation 6 of Embodiment 1;

FIG. 17 is a diagram illustrating information used when product information is registered in response to a replacement button;

FIG. 18 is a diagram illustrating an example of a screen of a replacement button and a product list which are displayed on a display when product A is replaced with product B;

FIG. 19 is a flowchart illustrating a processing procedure in Variation 7 of Embodiment 1;

FIG. 20A is a diagram illustrating information used when product information is registered by using an external device;

FIG. 20B is a flowchart illustrating a processing procedure in Variation 8 of Embodiment 1;

FIG. 21 is a diagram illustrating an overall configuration diagram of a showcase system according to Embodiment 2;

FIG. 22 is a flowchart illustrating a processing procedure in Embodiment 2;

FIG. 23 is a diagram illustrating a display example of hierarchical information;

FIG. 24 is a flowchart illustrating a processing procedure in Variation 3 of Embodiment 2;

FIG. 25 is a diagram illustrating a display screen of Variation 4 of Embodiment 2; and

FIG. 26 is a flowchart illustrating a processing procedure of Variation 4 of Embodiment 2.

### DESCRIPTION OF EMBODIMENTS

Hereinafter, each embodiment of the present disclosure will be described in detail with reference to the drawings and tables. However, more than necessary detailed description, for example, detailed description of well-known matters or duplicate description for substantially the same configurations may be omitted. The following description and the drawings and tables referred to herein are provided for understanding the present disclosure by a person skilled in the art and are not intended to limit the claims of the present disclosure.

### Embodiment 1

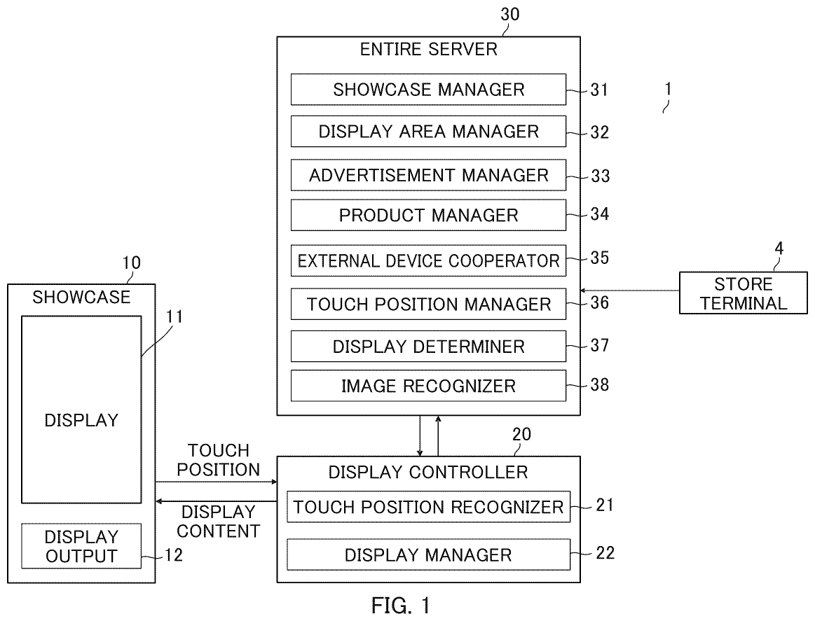

A configuration of showcase system 1 will be described with reference to FIG. 1. As illustrated in FIG. 1, showcase system 1 includes showcase 10, display controller 20, entire server 30, and store terminal 4. Display controller 20 and entire server 30 are configured to perform display control of transmissive touch display 11 of showcase 10, and can be regarded as a controller.

### (Showcase 10)

Showcase 10 can be installed in a place according to a use purpose, a function, and a target user, for example, a convenience store, a supermarket, a department store, a specialty store, a restaurant, a cafe, a hotel, a hospitality facility, an airport, a railway station, an exhibition, an event venue, a library, a museum, an office, an enterprise facility, a school, or an educational facility.

Showcase 10 includes transmissive touch display 11. Further, showcase 10 can include: a speaker that can output a voice; a shelf or a tray for displaying a product; a lighting device for improving visibility of the product; a cooling device or a heating device for cooling or heating the product; a temperature sensor for monitoring an inside temperature of the showcase; a sensor that reacts to a customer; camera 13 that captures an image of the customer; a drainage system that appropriately drains condensation water generated in the showcase or water during defrosting; a condensation prevention heater that prevents condensation on a glass surface; and casters that facilitate movement of the showcase.

Showcase 10 can display a product inside the showcase. Showcase 10 includes: for example, a horizontal layout in which a plurality of products are horizontally disposed; a vertical layout in which a plurality of products are vertically displayed; a grid layout in which products are disposed in a grid pattern; a zone layout in which the inside of the showcase is divided into zones according to a type or a size of the product; and a display layout in which these layouts are combined. The display layout of the product can be appropriately selected according to a size of the product, a product characteristic, visibility of the product, and the like. Showcase 10 may be a planar showcase in which the product is visually recognized from above. Such a planar (flat) showcase includes two types, for example, a freezer/refrigerator type used in a convenience store, a supermarket, and the like, and a type that has no frozen/refrigerated/heating function, used in a jewelry store, a watch store, and the like.

Showcase 10 includes at least one door for a customer or a store clerk (hereinafter, may be referred to as “employee”) to take out and put in a product inside the showcase. The door may be provided on a front side or may be provided on a back side opposite to the front side. When the door is provided on the front side, the customer can directly access the product, which is suitable for a self-service type store or installation for the purpose of sales promotion. Meanwhile, when the door is provided on the back side, it is suitable for a store clerk to take out and replenish a product from a stock room. This disposition is suitable for handling a product that requires hygiene management, such as food, or an expensive product, by limiting access to the product inside the showcase to the store clerk. Further, the door can be provided on both the front side and the back side. As a result, the store clerk can replenish the product from the stock room, and the customer can take out the product from the front side, so that it is possible to simultaneously realize efficient product management and convenience of the customer. Further, the door may be provided on a side surface of the showcase.

The opening and closing direction of the door of showcase 10 may be selected and designed in consideration of various factors, such as a space of an installation location, a product characteristic, convenience of a user, and energy efficiency. The door of showcase 10 may be, for example, a side-hinged type adopted in a convenience store, a supermarket, and the like, a vertical-hinged type (upward opening/downward opening), or a sliding door type.

The number of doors of showcase 10 may be selected and designed in consideration of various factors, such as an operation mode of the store, a product lineup, a need for temperature control, and a purchasing behavior of the customer. For example, a showcase may have a single door provided with one large door for the entire showcase, or may have a plurality of doors, respectively provided to a plurality of sections resulting from dividing the inside of the showcase.

### (Transmissive Touch Display 11)

Showcase 10 includes at least one transmissive touch display 11 for displaying product information or an advertisement to a user including a customer or a store clerk. Transmissive touch display 11 may be provided at any position of showcase 10. For example, transmissive touch display 11 may be installed as a touch display door integrated with a door on the front side of showcase 10, and may be provided on the front side without being integrated with the door when the door is provided only on the rear side. Further, transmissive touch display 11 for the customer may be provided on the front side, and transmissive touch display 11 for store clerks in the stock room may be provided on the rear side. Further, when showcase 10 is a planar type, transmissive touch display 11 may be provided on an upper surface.

Transmissive touch display 11 is a display device incorporating a touch screen technology. The transmissive display (transmissive display device; hereinafter sometimes simply referred to as “display”) provided in transmissive touch display 11 is a transmittance controllable display and can selectively and stepwise switch between a transmissive state/opaque state (further, a semi-transmissive state in some cases). The touch screen is installed on the transmissive display provided in transmissive touch display 11, and includes a sensor that senses a touch operation by a finger or a stylus of a user.

The term “display screen” in Embodiment 1 is an area in which display dots (pixels) are provided, and refers to an area in which an image, a video, a character, or the like is actually displayed. For the display screen, this area is determined, for example, by a physical size or a resolution of transmissive touch display 11.

The term “touch screen” in Embodiment 1 is an area in which a touch sensor is provided and refers to an area in which the user can perform a touch operation.

Since the touch screen in Embodiment 1 is integrally provided with the display screen, the display screen and the touch screen may be collectively referred to as a “screen” hereinafter. Since transmissive touch display 11 has excellent transmittance, transmissive touch display 11 displays digital information on the product without overlapping the product inside the showcase while the product itself inside the showcase is visually recognized, and provides visual interaction to the customer.

The size of the display screen (display area) and the size of the touch screen (touch area) are preferably the same, but not necessarily the same. In Embodiment 1, the sizes of the display screen and the touch screen will be described as being the same.

Transmissive touch display 11 has a transmissive mode and a mode composed of an advertisement mode and a registration mode.

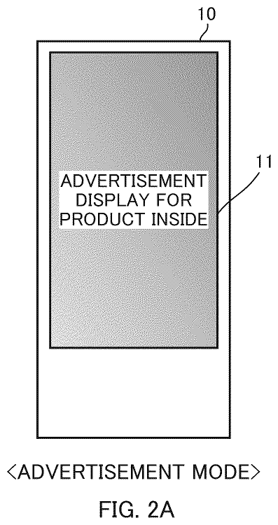

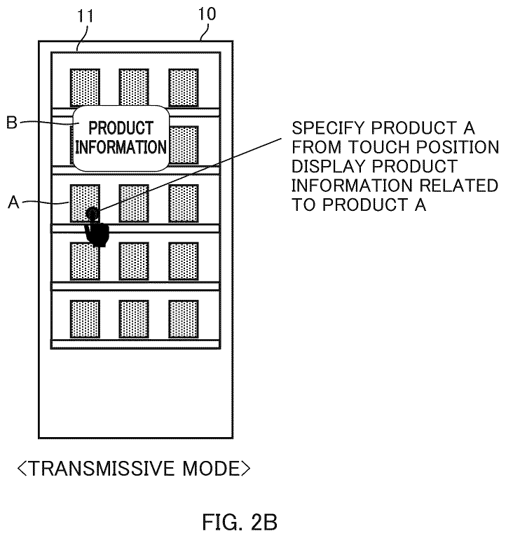

FIGS. 2A and 2B are diagrams illustrating the “advertisement mode” and the “transmissive mode”. The “advertisement mode” and the “transmissive mode” will be described with reference to FIGS. 2A and 2B. As illustrated in FIG. 2A, the “advertisement mode” is a display mode in which product information and/or information on an advertisement of the product is displayed on a part of or an entirety of the surface of the screen. In the advertisement mode, the customer cannot visually recognize or has difficulty in visually recognizing product A behind and in the vicinity of a display area of information on the product displayed on the screen of transmissive touch display 11 and/or information on the advertisement of the product among products A displayed in the showcase. As illustrated in FIG. 2B, the “transmissive mode” is a display mode in which product A displayed inside showcase 10 is made visible by using the transmittance of transmissive touch display 11, and information on product A and/or information on the advertisement of the product is displayed on a part (display area) of the screen in response to a touch event. Here, the term “touch event” refers to detection of an event in which a part of the screen is touched by a person. In FIG. 2B, for example, when the customer touches the screen on which product A is displayed, the product is specified from the touched position, and product information B of the specified product is displayed on the screen. The term “registration mode” is an operation mode for registering information on the replaced product and information on the advertisement on the screen of transmissive touch display 11 when the product displayed in showcase 10 is replaced. The “registration mode” will be described in Variation 7 of Embodiment 1.

Switch from the “transmissive mode” to the “advertisement mode” automatically to the advertisement mode is possible, for example, when the customer is not present in front of the showcase, and the camera or the human sensor detects the situation. Specifically, when it is detected that no one has been present in front of the showcase for a certain time, transition is made automatically from the transmissive mode to the advertisement mode.

The switch from the advertisement mode to the transmissive mode is possible, for example, when it is detected that a customer has approached the showcase or that a customer has approached the showcase and has made an operation (such as a line of sight or a touch) of showing interest in the product. Specifically, when the camera detects a line of sight or a touch motion of a customer and recognizes that the customer is standing in front of the product, switching to the transmissive mode can be automatically made.

The switch from the transmissive mode to the registration mode is possible by a store clerk manually selecting the registration mode using a dedicated panel or a remote device in order to perform a maintenance work, for example. Specifically, the store clerk can switch from the transmissive mode to the registration mode by operating a switch button to the registration mode when replacing the product.

The switch from the registration mode to the transmissive mode can be performed, for example, when the maintenance work is completed, a store clerk presses an operation completion button, or a certain time has elapsed. Specifically, when registration of the product information is completed and a store clerk presses a button to end the mode, the mode returns to the transmissive mode. Alternatively, the mode can be automatically switched when a certain time has elapsed.

The switch from the advertisement mode to the registration mode can be manually performed from the advertisement mode to the registration mode, for example, by a store clerk in order to start the maintenance work. Specifically, the store clerk can perform an operation of switching to the registration mode, using a remote device or a dedicated panel for work.

The switch from the registration mode to the advertisement mode can be automatically performed to the advertisement mode when a store clerk performs a work end operation or a certain time has elapsed upon completion of maintenance work. Specifically, the mode is switched to the advertisement mode when a store clerk operates or a certain time has elapsed after completion of the maintenance work.

Transmissive touch display 11 includes a touch sensor that accurately detects that a finger of a customer touches the touch screen. An example of the touch sensor is a capacitive sensor. A capacitive sensor detects a change in the capacitance by the finger touching an electrode disposed in the touch screen. The capacitive sensor has electrodes disposed in a lattice shape in the X direction and the Y direction in transmissive touch display 11, and transmissive touch display 11 is divided into a large number of small sensor cells. The electrodes in the X direction and the electrodes in the Y direction are disposed in layers different from each other, and a point (sensor cell) at which a touch is detected at a portion where these electrodes intersect each other is formed. With such a structure, the entire touch screen becomes an aggregate of fine sensor cells, and a change in capacitance can be detected in each cell. When a finger of a user touches a surface of the touch screen, the capacitance between the fingertip and the electrode on the surface of the touch screen changes. This change is maximized at the electrode (in the X direction and the Y direction) at the position touched by the finger. The capacitive sensor can specify the position touched by the finger by detecting the capacity change in real time. The electrodes in the X direction and the electrodes in the Y direction are sequentially scanned, and in which electrode pair a change in capacitance has occurred can be detected. The electrodes in the X direction correspond to a “column”, the electrodes in the Y direction correspond to a “row”, and a position (x, y) where the row and the column intersect is the touched position.

An image or video related to the product or the advertisement displayed on transmissive touch display 11, a video signal for transmitting information on a user interface, a signal for controlling an operation of the display, and the like are input to transmissive touch display 11. The voice signal can be output through a speaker provided in showcase 10. Further, a touch detection signal including coordinate data and a signal for notifying an external system of an operation state of the display or an error status are output from transmissive touch display 11.

### (Display Output 12)

Transmissive touch display 11 includes display output 12. Display output 12 controls a screen of transmissive touch display 11 based on an instruction from display controller 20. The instruction from display controller 20 is, for example, a display content instruction for designating content (e.g., product information, an advertisement, or an interface element) to be displayed on the screen, a layout instruction for instructing disposition or layout of a display area on the screen, a mode switching instruction for instructing switching to a transmissive mode, an advertisement mode, or the like, or a brightness adjustment instruction for adjusting brightness or contrast. Display output 12 performs appropriate screen display on the screen of transmissive touch display 11 in response to these instructions.

### (Display Controller 20)

Display controller 20 is a device that manages and controls information displayed on the screen of transmissive touch display 11. Display controller 20 makes it possible to display appropriate information on the screen of transmissive touch display 11 in corporation with entire server 30. Display controller 20 can be provided inside showcase 10, on an external rear surface or a side surface of showcase 10 or a location separated from showcase 10. The installation location may be selected based on the usage, design, environment, maintainability, and the like of showcase 10. Display controller 20 may manage and control one transmissive touch display 11 or may collectively manage and control a plurality of transmissive touch displays 11. Display controller 20 includes touch position recognizer 21 and display manager 22.

### (Touch Position Recognizer 21)

Touch position recognizer 21 obtains a pair of coordinates (x, y) of a touch position (hereinafter, may be referred to as a “touch position coordinate (x, y)”) of at least one touch operation performed on the touch screen of transmissive touch display 11.

As a method for indicating a touch position coordinate (x, y) on a touch screen (may be referred to as an “indication method”), for example, the following methods can be used: an indication method with a touch position coordinate in units of pixels, an indication method with a distance from a reference point, an indication method with electrode numbers included in the touch sensor, an indication method with normalized coordinates, and an indication method with a zone.

For the method for indicating a touch position with pixel coordinates on the screen, a pair of coordinate values (x, y) (hereinafter, may be referred to as a “coordinate value (x, y)) corresponding to the resolution of the screen is used. For example, for a screen having a resolution of 1920×1080, the touch position is detected in a range in which x is in a range of 0 to 1919 and y is in a range of 0 to 1079.

For the method for indicating a touch position with a distance from a specific reference point (e.g., an upper-left origin, a lower-left origin, or a center origin) on the screen, a physical length such as centimeters or inches is used as a unit of distance instead of pixels. This is because the physical size of the display is dependent on the display, and even with the same resolution, the numerical value of the distance is different when the display size is different. When the distance is used as a unit, the touch position or the display position can be set in conjunction with the actual physical size, such as the size or the display position of the product inside the showcase and the height of the customer.

For the method for indicating a touch position based on an electrode number used in the touch panel, since the touch sensor usually has electrodes disposed in a lattice shape on the screen, the touch position can also be specified by the electrode numbers in the vertical and horizontal directions of the lattice. For example, when 10 electrodes are present in the x-axis direction and 20 electrodes are present in the y-axis direction, the position is indicated by a pair of electrode numbers (5, 10) (hereinafter, referred to as an “electrode number” (5, 10)). Note that, since the resolution of the touch position depends on the number of electrodes, it is difficult to specify a fine touch position when the density of the electrodes is low.

The indication method using normalized coordinates is a method for indicating a touch position using normalized coordinates in which the width and the height of the screen are set to 1. For example, the upper left of the screen is set to (0, 0), and the lower right of the screen is set to (1, 1). As a result, it is possible to designate a position that does not depend on the resolution or the size of the screen.

The indication method with zones is a method for dividing the screen into a plurality of zones or regions and indicating the position by the zone number or the name thereof. For example, the display is divided into 15 zones of 5×3, and each area is identified by the number or label.

When a plurality of touch inputs are continuously made, touch position recognizer 21 may, for example, make only the first detected touch position valid, may make only the last detected touch position valid, or may make only the touch input within a predetermined time among the plurality of continuous touch inputs valid. Further, when a plurality of touch inputs is simultaneously input, for example, the plurality of touch inputs may be respectively recognized as separate touch operations and may be individually processed. Further, when a plurality of touch inputs is input, touch position recognizer 21 may output a command for displaying an error message on the display to display output 12. As a result, an erroneous operation by a customer can be prevented. Further, when a plurality of touch inputs is input, touch position recognizer 21 may output a command to cancel any operation and return to the original state to display output 12.

When a new touch input is received under certain conditions (e.g., when an action being operated has not been completed), touch position recognizer 21 can avoid confusion in the operation by making the operation invalid.

Touch position recognizer 21 may output a command to display visual feedback (e.g., highlight or effect) at the touched position to notify the customer that the touch has been recognized. Further, when the touch has been recognized, a command to provide acoustic feedback to notify the customer that the touch operation has been received may be output.

Touch position recognizer 21 transmits a position of at least one touch operation performed on the touch screen of transmissive touch display 11 to touch position manager 36 of the entire server as a pair of coordinate values (x, y).

### (Display Manager 22)

Display manager 22 outputs an instruction to control transmissive touch display 11 to display output 12 in response to an instruction from display determiner 37 of entire server 30. The instruction from display determiner 37 of server 30 is, for example, an instruction for displaying content (e.g., product information, an advertisement, or an interface element) to be displayed on the screen of transmissive touch display 11 in a designated display area, or a mode switching instruction for instructing switching to a transmissive mode, an advertisement mode, a registration mode, or an off mode. Note that, the off mode refers to a mode in which the power of transmissive touch display 11 is turned off.

### (Entire Server 30)

Entire server 30 (hereinafter, may be referred to as “entire server 30”) is a central computer system that collectively performs management of showcase 10 provided in each store, management of advertisement, management of products, determination of display content, and processing of various types of data in showcase system 1, and is configured to optimize an interaction between customers and products. Entire server 30 integrally manages and controls information displayed on transmissive touch display 11 and integrates a plurality of functional modules. The installation location of entire server 30 is, for example, a stock room of a store, an office, a server room, a cloud environment, or a data center. The connection between entire server 30 and display controller 20 is, for example, a wired, radio, or remote connection via the Internet. The installation location and the connection of entire server 30 can be appropriately selected based on an operation form of the system, real-time performance, and security requirements. As illustrated in FIG. 1, entire server 30 includes showcase manager 31, display area manager 32, advertisement manager 33, product manager 34, external device cooperator 35, touch position manager 36, display determiner 37, and image recognizer 38.

### (Showcase Manager 31)

Showcase manager 31 stores showcase information related to each showcase 10 provided in each store. The “showcase information” is information related to showcase 10, such as an installation location of the showcase, the presence or absence of transmissive touch display 11, and a size of the touch screen.

An example of the “showcase information” may be provided by a database composed of a store ID that is a unique identification number for identifying the store, a showcase ID that is a unique identification number for identifying showcase 10, a display ID that is a unique identification number for identifying transmissive touch display 11, and a size of the display, as indicated in Table 1.

TABLE 1

| Store ID | Sequence ID | Display ID | Display size |
|---|---|---|---|
| ST001 | SC001 | DIS001 | 43 inch |
| ST002 | SC002 | DIS002 | 43 inch |
| ST003 | SC003 | DIS003 | 55 inch |

The “showcase information” may include, in addition to the above, information, such as specification information, an installation location, a maintenance status, an operation start date, and the last maintenance date of the showcase.

### (Display Area Manager 32)

Display area manager 32 stores display area information for setting in which area on the screen displays information on the product and/or information on the advertisement is displayed. The “display area information” is data related to an area in which specific information (product, advertisement, text, image, video, or the like) is displayed on the screen of transmissive touch display 11.

The “display area information” is provided by a database having, for example, as indicated in Table 2: a display ID that is a unique identification number for identifying transmissive touch display 11; a display area ID that is a unique identification number for identifying a display area on transmissive touch display 11; a display area name; a start position (x1, y1) and an end position (x2, y2) of the display area; a size (width×height) of the display area; and a product ID that is a unique identification number for identifying a product. The position and the size of the display area are represented in units of pixels (the same applies to the following description).

Further, the term “display area” refers to an area specified by a position and a size on the display screen, and in principle, one product is associated with one display area.

TABLE 2

| | | | Start position (x1, y1) and | Size of display | |
|---|---|---|---|---|---|
| | | Name of | end position (x2, y2) of | area (width × | |
| Display ID | Display area ID | display area | display area | height) | Product ID |
| DIS001 | Display Area_1 | Display area 1 | (100, 200)~(600, 700) | 500 × 500 | Product_Z |
| DIS001 | Display Area_2 | Display area 2 | (400, 150)~(900, 650) | 500 × 500 | Product_Y |
| DIS001 | Display Area_3 | Display area 3 | (50, 100)~(550, 600) | 500 × 500 | Product_X |

Furthermore, with reference to Table 2 and FIG. 2B, an area on the screen in which product information B of FIG. 2B is displayed corresponds to the display area of Table 2. A position of product information B on the screen corresponds to the start position (x1, y1) and the end position (x2, y2) of Table 2, and a size of product information B on the screen corresponds to the size (width×height) of the display area of Table 2. Product information B of FIG. 2B corresponds to the product to which the product ID of Table 2 is assigned.

Regarding the first row of Table 2, a display area 1 having DisplayArea_1 as a display area ID is an area of (100, 200) to (600, 700) as a start position and an end position on the screen, has a size of width 500×height 500 pixels, and indicates that an area in which information on product Z identified with Product_Z as a product ID is displayed is the display area 1.

The numerical values of Table 2 are merely exemplary. As indicated in Table 2, the sizes of the plurality of display areas may not be the same or the shapes of the plurality of display areas may not be the same. The display area may have any shape. For example, the display area may have a polygonal shape, a circular or elliptical shape with a predetermined point on the screen as a center point, or a shape that imitates a contour of the product. The position and the size of the display area may be set to match a display layout of the product in the corresponding showcase.

Display area manager 32 may have an algorithm for automatically setting the position, the size, and the shape of the display area. For example, an algorithm for optimization by feedback of user data can be used. The number of touch operations by the user is accumulated, and the display area for a product that is frequently touched by the user (that is associated with a touch position specification region where the user frequently performs a touch operation) can be preferentially set to be larger than display areas for other products. Conversely, the display area for product information related to a product with a small number of touch operations may be set larger. Further, the size of the touch position specification region itself may be changed according to the number of touch operations. Further, an algorithm for reflecting environmental data in real time can be used. Information from an environmental sensor or a camera may be incorporated to dynamically set a display area according to the intensity of surrounding light, the position of the customer, the line of sight direction, and/or the like. As a result, the position and the size of the display area can be set based on the angle from which the customer views the display and the distance at which the customer is present. Further, an algorithm for processing a plurality of pieces of information at the same time can be used. When a plurality of pieces of information is displayed at the same time, the display area can be reset to display information with a high priority larger by automatically discriminating a priority of the information to be displayed. As a result, important information for the user is not overlooked. Furthermore, past data may be fed back to a machine learning algorithm to improve the efficiency of selection and size adjustment of the display area. As a result, the accuracy and the efficiency of the information to be displayed improve, thereby, making the operation of transmissive touch display 11 more intuitive and easier to use.

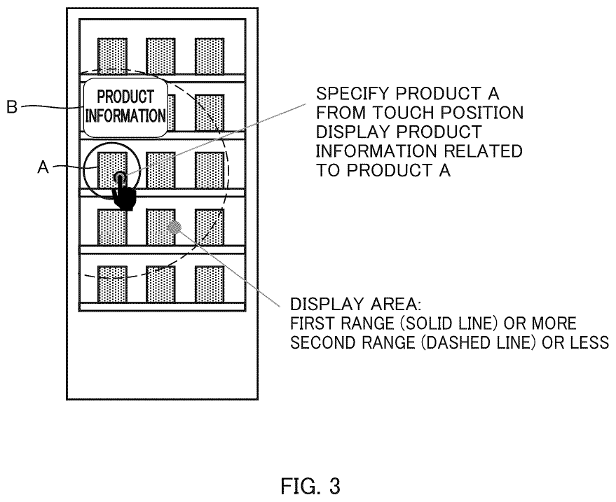

The “display area information” is not limited to the information of Table 2 and may include information on a display form in the display area on the screen, such as a priority for hierarchical display, a size and a resolution of a font or an image, a display time, a display period, and a visual effect (presence or absence of a fade-in, a slide-in, or the like). FIG. 3 is a diagram illustrating an example of the display area. As illustrated in FIG. 3, when a customer who is interested in product A touches the screen near product A, information on product A corresponding to the touch position is displayed in the display area as product information B. In this case, the display area is set to a ring-shaped area defined by a first circular range (solid line) and a second circular range (dashed line) wider than the first range. The center of the circular first range (solid line) is provided at a position overlapping product A, for example, as viewed from the front of product A. The radius of the circular first range (solid line) is set such that the range overlaps product A. That is, the area of the circular first range (solid line) is set such that, even when product information B is displayed, product A viewed from front by the customer and product information B do not overlap with each other as seen through transmissive touch display 11. The center of the circular second range (dashed line) is set to, for example, the same point as the circular first range (solid line). The radius of the circular second range (dashed line) is set according to a display size of product information B. In the case of FIG. 3, the display area is set to a ring shape centered on product A that is a touch target, but may have, for example, a polygonal shape with a hollow center.

### (Advertisement Manager 33)

Advertisement manager 33 registers and stores advertisement product information to be displayed in the display area on the display screen of transmissive touch display 11. The “product advertisement information” is information related to a short-term and/or promotional message or promotion that is transmitted to a target consumer for the purpose of promoting the purchase of a specific product. The “product advertisement information” is mainly used when the display mode of transmissive touch display 11 is the advertisement mode.

TABLE 3

| | Name of | |
|---|---|---|
| Product ID | product | Content of advertisement |
| Product_X | Product X | Advertisement related to Product X |
| Product_Y | Product Y | Advertisement related to Product Y |
| Product_Z | Product Z | Advertisement related to Product Z |

The “advertisement information on the product” is provided as a database composed of, for example, as indicated in Table 3, a product ID set to uniquely identify a product, a product name, and an advertisement content.

The “advertisement information on the product” is not limited to these described above and can further include various types of information. Specifically, the “advertisement information on the product” may further include a display time and a display period of the advertisement, a target customer group, a price of the product, an inventory status, related promotion information, a related recipe and product information used in the recipe, manufacturer information, a past sales history, a customer evaluation or review information, product component or specification information, and real-time market trends. In particular, with the recent increase in health consciousness, enabling the display of the product components allows the customer to immediately check the presence or absence of and types of allergen substances or additives for a plurality of products without taking out the product. As a result, the opening and closing of the door is suppressed, and the inside temperature of the cold equipment, such as the showcase in which the product is stored is suppressed from increasing, so that the energy saving performance can be improved. These pieces of information can also be in a form that is dynamically updated in order to maximize the effects of the advertisement. The database is not limited to being fixedly set for a single product and can also include information shared among a plurality of products or information corresponding to different product categories. Furthermore, the “advertisement information on the product” may have a hierarchical structure, and for example, can be configured to be divided into a plurality of fields or subcategories related to the product according to a customer group or a priority, and each field or subcategory is displayed based on a specific condition. For example, specific advertisement information may be preferentially displayed according to the customer group or the priority.

### (Product Manager 34)

Product manager 34 registers and stores product information to be displayed in the display area on the screen of transmissive touch display 11. The “information on the product” is information that is based on facts and is objective details, features, functions, usage methods, components, specifications, and the like of a predetermined product, which is helpful for a consumer to understand and use the product. The “information on the product” is mainly used when the display mode of transmissive touch display 11 is the transmissive mode.

TABLE 4

| | Name of | | | Name of |
|---|---|---|---|---|
| Product ID | product | Content of product | Category ID | category |
| Product_X | Product X | Advertisement related to Product X | Category_1 | Category 1 |
| Product_Y | Product Y | Advertisement related to Product Y | Category_2 | Category 2 |
| Product_Z | Product Z | Advertisement related to Product Z | Category_3 | Category 3 |

The “information on the product” is provided as a database composed of, for example, as indicated in Table 4, a product ID set to uniquely identify the product, a product name, a product content, a category ID set to uniquely identify the category of the product, and a category name. The category ID can be used in generating a predetermined product list. Furthermore, a subcategory ID may be provided to be set more finely. The product list can be used, for example, in generating a product list in the registration mode of the product.

The “information on the product” is not limited to these and can further include various types of information. Specifically, information based on a target customer group (age, gender, region, and the like), sales performance or review information of the product, a total number of times a customer has touched the product, and a real-time inventory status can also be included. These pieces of information can be dynamically updated, and product information can be set based on the interest or the purchase history of the customer.

### (External Device Connector 35)

External device cooperator 35 performs data cooperation with external devices, such as a barcode reader and store terminal 4.

### (Touch Position Manager 36)

Touch position manager 36 acquires touch event information related to a touch event by a customer. The “touch event information” is provided as a database composed of, for example, as indicated in Table 5, a touch ID set to identify the touch event and a position coordinate (x, y) on the touched screen.

TABLE 5

| Touch ID | Touch position coordinates (x, y) |
|---|---|
| Touch_1 | (100, 100) |

Although not indicated in Table 5, the “touch event information” may include a time at which the touch is performed, a display ID for identifying transmissive touch display 11 on which the touch is performed, a store ID, and the like. By analyzing when and in which time slot the touch frequently occurs using the touch event information, the behavior pattern of the user can be understood. In a case of operating a plurality of stores, by including the store ID, the usage status of each store and the frequency of occurrence of the touch event can be understood, so that the performance of each store can be compared and thus the marketing strategy can be applied.

Touch position manager 36 further compares the touch position coordinates (x, y) with a coordinate range of the touch position specification region on the preset transmissive touch display 11 to specify a region to which the touch position coordinates (x, y) belong. Touch position manager 36 has touch position specification region information for performing the specification.

TABLE 6

| Touch position | | | | |
|---|---|---|---|---|
| specification | Name of touch position | Start position and end position of | Size of touch position | |
| region ID | specification region | touch position specification region | specification region | Product ID |
| Region_A | Touch position | (0, 0)~(500, 300) | 500 × 300 | Product_X |
| | specification region A | | | |
| Region_B | Touch position | (500, 0)~(1000, 300) | 500 × 300 | Product_Y |
| | specification region B | | | |
| Region_C | Touch position | (300, 300)~(800, 600) | 500 × 300 | Product_Z |
| | specification region C | | | |

The “touch position specification region information” is provided as a database composed of, for example, as indicated in Table 6, a touch position specification region ID set to uniquely identify the touch position specification region, a touch position specification region name, a start position and an end position of the touch position specification region, a size of the touch position specification region, and a product ID.

The “touch position specification region” refers to an area divided into a plurality of regions on the display screen to specify the touched position and is a region for associating the touch event with the product. The disposition layout of the “touch position specification region” is disposed on the screen to match the product layout displayed in the showcase. Basically, the disposition of one touch position specification region matches the disposition of one product. For example, when the same product is displayed side by side in three, the touch position specification region may be set to have three side-by-side regions corresponding to the three products or may be set to one in consideration of the fact that the three products are the same product.

For example, when touch position manager 36 acquires touch position coordinates (100, 100), touch position manager 36 compares the touch position coordinates (100, 100) with the coordinate range (start position and end position of the touch position specification region) of the touch position specification region. It is determined that the touch position (100, 100) belongs to the coordinate range (0, 0) to (500, 300) of touch position specification region A. Therefore, touch position manager 36 specifies that the touch position (100, 100) belongs within touch position specification region A.

Touch position manager 36 generates touch position association information for associating the touch position coordinates with the touch position specification region. The touch position association information is composed of, for example, as indicated in Table 7, a touch ID, a touch position specification region ID, and a product ID.

TABLE 7

| | Touch position | |
|---|---|---|
| | specification | |
| Touch ID | region ID | Product ID |
| Touch_1 | Region_A | Product_X |

With reference to the example of Table 7, when a touch event identified as Touch 1 occurs as the touch ID, it is indicated that product X (product ID: Product_X) associated with touch position specification region A identified as Region_A as the touch position specification region ID is a target product to be displayed on the screen. The touch position association information serves a role of linking the dynamically generated touch operation with the preset static product information. This “dynamic” and “static” association is important in displaying the product information in real time and is a mechanism for reflecting the product information immediately in response to the operation of the user.

### (Display Determiner 37)

Display determiner 37 generates display content information for determining which area on the screen displays the product content and the advertisement content related to the product by inquiring (querying) the information related to the touch position association information using the touch position association information. The display content information is composed of, for example, as indicated in Table 8, a touch ID, a display area ID, a start position (x1, y1) and an end position (x2, y2) of the display area, a product ID, a product content, and an advertisement content.

TABLE 8

| | | Start position (x1, y1) | | | |
|---|---|---|---|---|---|
| | Display | and end position (x2, y2) | | | Advertisement |
| Touch ID | area ID | of display area | Product ID | Product content | content |
| Touch_1 | DisplayArea_3 | (50, 100)~(550, 600) | Product_X | Advertisement related | Advertisement |
| | | | | to Product X | related to Product X |

In a case of describing Table 8, when there is a touch identified as Touch_1, it means that the product content and/or the advertisement content related to the product X are displayed at a position of (50, 100) to (550, 600) on the screen in DisplayArea_3.

The display content information may include the store ID and the display ID indicated in Table 1. When the display content information includes information on the store and the display, a transmission destination of the display content information can be specified.

Display determiner 37 outputs the display content information to display manager 22 of display controller 20. Display manager 22 commands display output 12 to display the product content and/or the advertisement content on the screen based on the display content information.

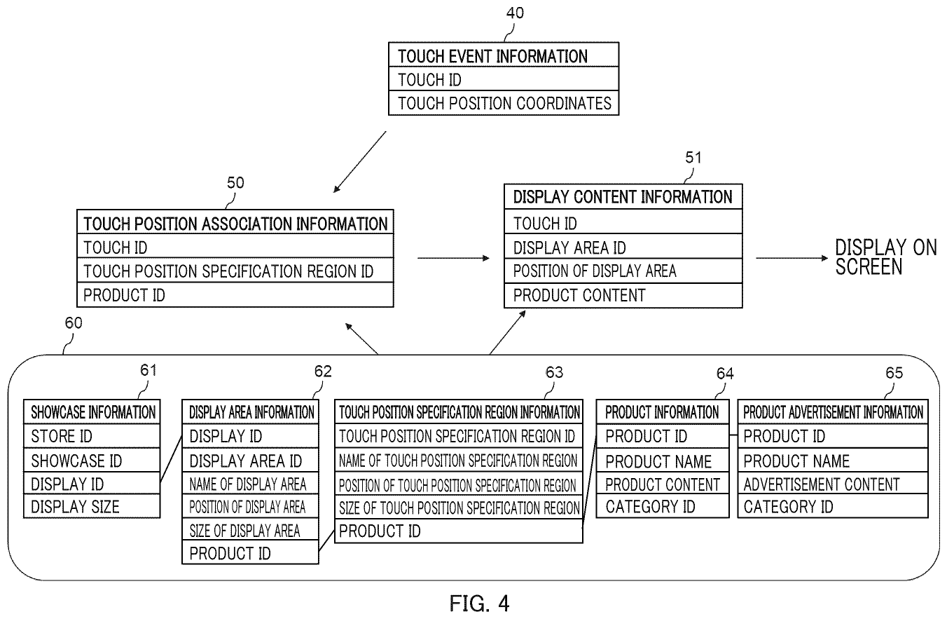

FIG. 4 is a diagram illustrating information used in displaying product information on the screen in response to the touch event. The information is composed of touch event information 40 that is information generated in response to the touch event, dynamic condition response information 60 that can be changed in response to an event other than the touch event, touch position association information 50 that associates touch event information 40 with dynamic condition response information 60, and display content information 51 that is generated from touch position association information 50 and dynamic condition response information 60.

Touch event information 40 is generated in response to the touch on the screen by a customer. The touch position coordinates of touch event information 40 are compared with the position of the touch position specification region of touch position specification region information 63 to specify the touch position specification region in which the touch event has occurred. That is, touch event information 40 and touch position specification region information 63 are associated with each other by this specification. In response to the association, touch position association information 50 is generated.

Display content information 51 is generated as a command related to the display content to be displayed on the screen from touch position association information 50 and dynamic condition response information 60. The display displays the product information or the advertisement in the display area on the screen based on display content information 51.

Dynamic condition response information 60 that can be changed in response to an event other than a touch event will be described. Dynamic condition response information 60 includes showcase information 61, display area information 62, touch position specification region information 63, product information 64, and product advertisement information 65. These pieces of information are associated with each other. For example, showcase information 61 and display area information 62 are associated with each other by the display ID, and display area information 62, touch position specification region information 63, product information 64, and product advertisement information 65 are associated with each other by the product ID. By dynamically changing some of the information in response to an external event (e.g., the position or the operation of the customer, or data of the environmental sensor), a more appropriate display form corresponding to the customer can be adopted, so that the customer experience can be improved. The display forms of a plurality of stores can be collectively changed, so that it is not necessary to individually set or change the display form for each store. As a result, time and effort can be significantly reduced, and the efficiency of the management work can be improved. Further, by the collective change, the same campaign or the same promotion information can be reflected in all stores at the same time. As a result, the brand image or the marketing strategy can be unified, and consistent information can be provided to the customer.

Table 9 indicates an example of an event other than a touch event. Some examples of the event other than the touch event will be described in Variations of Embodiment 1 described below.

TABLE 9

| Examples of event other | |
|---|---|
| than touch event | Description of event |
| Detection of motion sensor | Sensor event detecting customer moving toward or away from showcase. |
| Elapsed time | Timer event changing display content or advertisement after certain period of time has elapsed. |
| Input of environment sensor | Event in accordance with data from environmental sensors, such as brightness of lighting, |
| | temperature, or humidity. |
| Gaze detection | Event changing display in accordance with what customer looking at by tracking light of sight of |
| | customer via camera. |
| Face recognition | Event displaying appropriate products or advertisements based on age and gender by recognizing |
| | face of customer via camera. |
| Recognition of gesture of | Gesture event changing display content in accordance with movement when customer performs |
| hands or body | specific gesture. |
| Change of product | Event updating display to reflect changes when product arrangement within showcase is |
| arrangement | changed. |

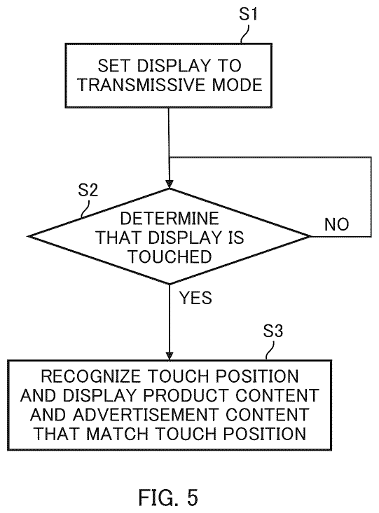

FIG. 5 is a flowchart illustrating a processing procedure in showcase system 1. The processing procedure of showcase system 1 will be described with reference to FIG. 5.

In Step S1, transmissive touch display 11 of showcase 10 is set to the transmissive mode.

In Step S2, it is determined whether a touch is recognized on the touch screen of transmissive touch display 11. When it is not determined that a touch is recognized, Step S2 is executed again. When it is determined that a touch is recognized, the processing proceeds to Step S3. The determination as to whether the touch is recognized is performed by touch position recognizer 21 and/or touch position manager 36. Touch position recognizer 21 determines whether the touch is recognized according to whether the touch position coordinates (x, y) can be specified. Touch position manager 36 determines whether the touch is recognized according to whether the region to which the touch position coordinates (x, y) belong can be specified.

In Step S3, the touch position coordinates (x, y) are specified, and the display content information including the product content and the advertisement content of the product corresponding to the touch position coordinates (x, y) is displayed in the display area.

### Variation 1 of Embodiment 1

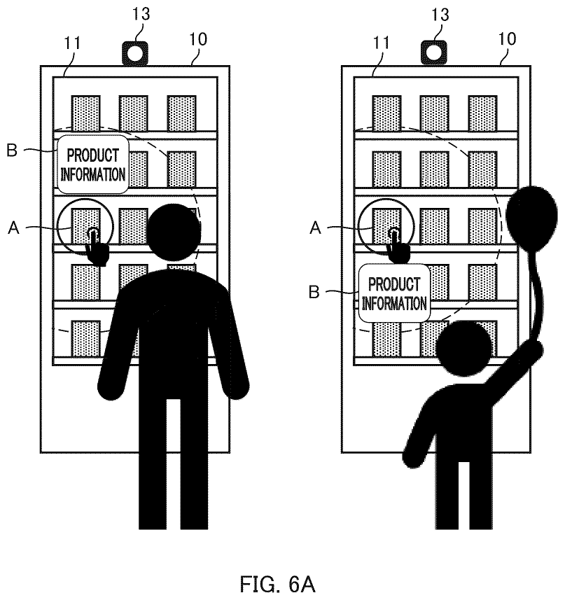

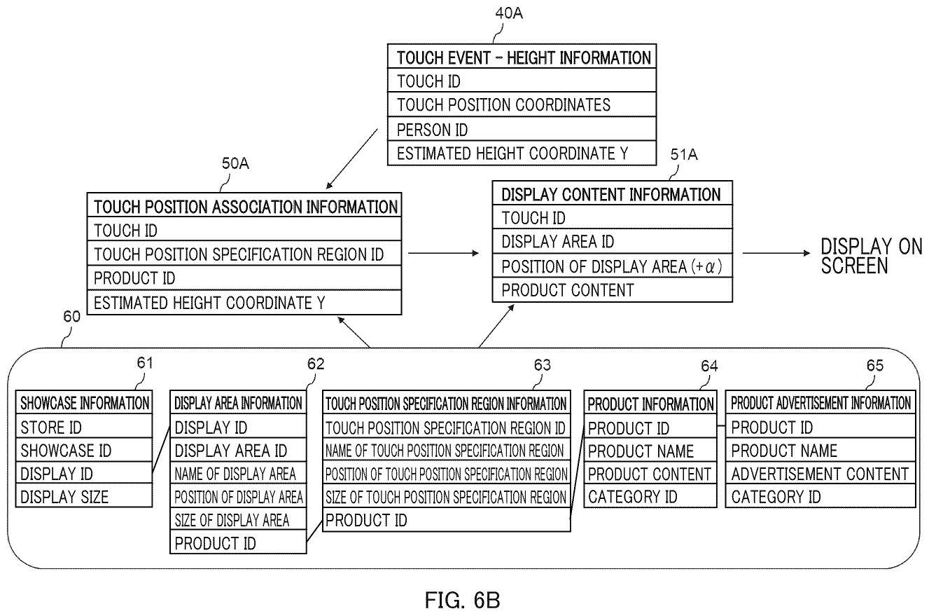

Variation 1 of Embodiment 1 will be described with reference to FIG. 6A. Variation 1 of Embodiment 1 is directed to an example of changing the position of product information B according to the height, as illustrated in FIG. 6A. Further, Variation 1 of Embodiment 1 can also be said to be directed to an example of changing dynamic condition response information 60 in response to an event other than a touch event. Specifically, showcase 10 includes camera 13 and is directed to an example of specifying the height of the customer from the video captured by the camera and setting the display area according to the specified height. That is, the event other than the touch event is to acquire the video captured by the camera. Then, display area information 62 of dynamic condition response information 60 is corrected in response to this event. As illustrated in FIG. 1, in Variation 1 of Embodiment 1, showcase 10 includes camera 13, and entire server 30 has image recognizer 38.

### (Camera 13)

Showcase system 1 according to Variation 1 includes at least one camera 13 in showcase 10. Camera 13 is installed on the upper surface of the showcase. Camera 13 is adjusted to face the front surface of showcase 10 in order to capture the entirety of a person. This is because it is necessary to image the person from the head to the foot. Regarding the resolution, an appropriate resolution is required in order to accurately recognize the head or the entire body of the person, and for example, a resolution of HD (1280×720) or higher is recommended. Regarding the angle of view, a wide angle of view (e.g., 120 degrees or more) is recommended in order to capture persons with different heights. In order to more accurately recognize the height, a plurality of cameras may be provided.

### (Image Recognizer 38)

Entire server 30 has image recognizer 38. Image recognizer 38 estimates the height of a person based on a video or an image captured by camera 13.

Image recognizer 38 first detects a person in front of showcase 10 from the image captured by camera 13. The contour of the detected person is extracted, and the overall image of the person is understood to specify the upper end (head) and the lower end (foot) of the person as coordinates on the screen. The height of the person is estimated based on the coordinates (Y coordinates) of the upper end and the lower end of the detected person. For example, the height can be estimated based on relative coordinates with reference to the frame of the showcase, which is known. The estimated height coordinate Y (vertical position on the screen) corresponding to the height of the person is estimated based on the coordinate information of the upper end and the lower end of the person detected on the image.

FIG. 6B is a diagram illustrating information used in displaying the product information on the screen according to the height in Variation 1 of Embodiment 1. Variation 1 of Embodiment 1 will be described with reference to FIG. 6B based on the information used.

### (Touch Position Manager 36)

Touch position manager 36 acquires a touch event-height information 40A related to the touch event by the customer and the height. “Touch event-height information 40A” is provided as a database composed of, for example, as indicated in Table 10, a touch ID set to identify the touch event, position coordinates (x, y) on the touched screen, a person ID assigned to identify the person of which the height is estimated, and estimated height coordinates.

TABLE 10

| | Touch position | | Estimated |
|---|---|---|---|
| | coordinates | | height |
| Touch ID | (x, y) | Person ID | coordinate Y |
| Touch 1 | (500, 500) | Person 1 | (100) |

Touch position manager 36 compares the y coordinate of the touch position coordinate with the estimated height coordinate Y.

When the estimated height coordinate Y is higher than the y coordinate of the touch position coordinates, that is, when the actual height of the person is higher than the actual touch position, for example, the “y coordinates of the start position (x1, y1) and the end position (x2, y2) of the display area” set by default as indicated in display area information 62 of Table 2 are corrected upward to issue an instruction to display the product content and/or the advertisement content at a position higher than the touch position.

When the estimated height coordinates Y are at the same level as the y coordinates of the touch position coordinates, for example, the “y coordinates of the start position (x1, y1) and the end position (x2, y2) of the display area” set by default as indicated in the display area information of Table 2 are corrected to issue an instruction to display the product content and/or the advertisement content at a position at the same level as the touch position. Regarding the term “at the same level”, when a difference between the estimated height coordinates Y and the Y coordinates of the touch position coordinate is within a certain allowable error range, it can be regarded as “at the same level”. For example, an allowable error range can be set to a range of +5 cm in terms of the actual distance. As a result, even when the match is not perfect, the error is defined as “at the same level” as long as it is within this range.

When the estimated height coordinate Y is lower than the y coordinate of the touch position coordinate, that is, when the actual height of the person is lower than the actual touch position, for example, the “y coordinates of the start position (x1, y1) and the end position (x2, y2) of the display area” set by default as indicated in the display area information of Table 2 are corrected downward to issue an instruction to display the product content and/or the advertisement content at a position at the same level as the touch position.

### (Display Determiner 37)

Display determiner 37 generates display content information 51A for determining which area on the screen displays the product content and the advertisement content related to the product by inquiring (querying) the information related to touch position association information 50A, using the correction instruction related to touch position association information 50A and the display position from touch position manager 36. The display content information is composed of, for example, as indicated in Table 11, a touch ID, an area ID, a start position (x, y+α) and an end position (x, y+α) of the display area in which the y coordinates are corrected by a, a product ID, a product content, and an advertisement content.

TABLE 11

| | | Start position and | | | |
|---|---|---|---|---|---|
| | | end position of | | | Content of |
| Touch ID | Area ID | display area | Product ID | Content of product | advertisement |
| Touch_1 | DisplayArea_3 | (50, 100 + α)~ | Product_X | Advertisement related | Advertisement related |
| | | (550, 600 + α) | | to Product X | to Product X |

Display determiner 37 outputs the display area in which the y coordinates of the start position (x1, y1) and the end position (x2, y2) of the display area set by default are corrected by α to display manager 22 of display controller 20. Display manager 22 commands display output 12 to display the product content and/or the advertisement content on the screen based on display content information 51A. In a case of correcting the display area set by default upward, α is a positive value, and in a case of correcting the display area downward, α is a negative value. The value of a is determined, for example, according to a relative difference between the estimated height coordinate Y of the person and the touch position coordinates.

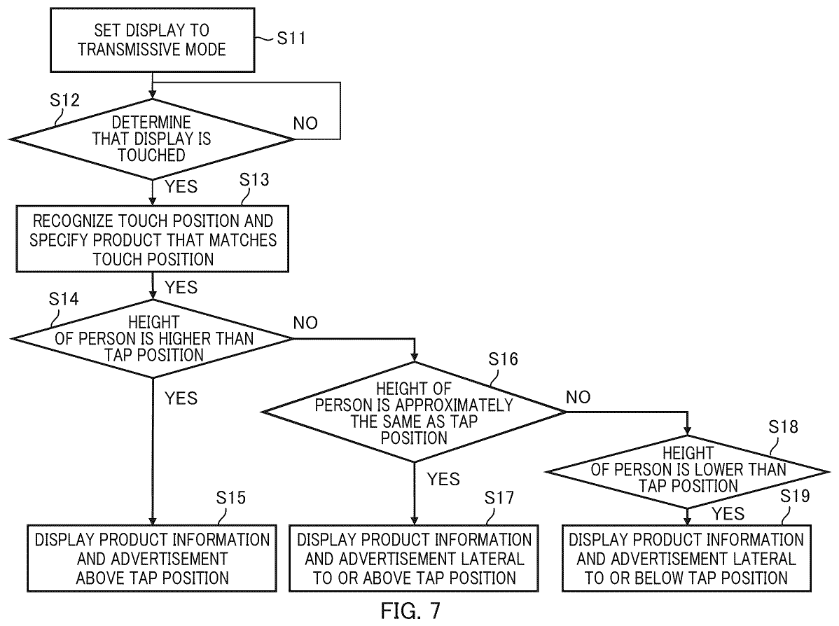

FIG. 7 is a flowchart illustrating a processing procedure of Variation 1 of Embodiment 1.

Since Steps S11 to S12 are the same as the flowchart of FIG. 4, the description thereof will be omitted.

In Step S13, the touch position coordinates (x, y) are recognized, and information related to the product corresponding to the touch position coordinates (x, y) and/or information related to the advertisement is specified.

In Step S14, the position (“tap position” in FIG. 7) of the product corresponding to the touch position coordinates (x, y) and the height estimated by image recognizer 38 based on the camera image captured by camera 13 are compared, and when the height of the person is higher than the position of the product, the processing proceeds to Step S15. When the height of the person is lower than the position of the product, the processing proceeds to Step S16.

In Step S15, the information related to the product and/or the information related to the advertisement is displayed on the screen at a position above the position of the product. In Step S16, when the height of the person is at the same level as the position of the product, the processing proceeds to Step S17. When the height of the person is not at the same level as the position of the product, the processing proceeds to Step S18.

In Step S17, the information related to the product and/or the information related to the advertisement is displayed on the screen at a position above or lateral to the position of the product.

In Step S18, when the height of the person is lower than the position of the product, the processing proceeds to Step S19.

In Step S19, the information related to the product and/or the information related to the advertisement is displayed on the screen at a position below or lateral to the position of the product.

The product information and the like can be adjusted to a display position that is easily visible to all customers. The comparison between the position of the product corresponding to the touch position coordinates and the height estimated by image recognizer 38 is not limited to the order illustrated in FIG. 7. For example, the order of the determination may be changed, the determination process may be omitted, or the display position of the product information and the advertisement after each determination may be changed, such as performing the determination of Step S18 first, executing Step S19 in a case of “Yes” in Step S18, performing the determination of Step S14 in a case of “No” in Step S18, executing Step S15 in a case of “Yes” in Step S14, and determining that “the height of the person is about the same as the tap” in a case of “No” in Step S14 and executing Step S17.

According to Variation 1 of Embodiment 1, since the display position of the product information or the advertisement can be flexibly adjusted upward, laterally, or downward based on the height of the customer, the optimal display position that is easy for all customers to see with a natural line of sight is provided. Since a display effect consistent for all customers, such as a tall customer, a short customer, and a customer having various body types can be obtained, it is possible to respond to a wide range of customer groups. As a result, the interactive user experience in the store is significantly improved through the adjustment of the display position according to the height of the customer, and the effect of the product or the advertisement can be effectively exhibited.

### (Variation 2 of Embodiment 1)

Variation 2 of Embodiment 1 will be described. Variation 2 of Embodiment 1 is directed to an example of considering a parallax that occurs in accordance with a distance between transmissive touch display 11 and the actual product. Specifically, showcase 10 includes a camera and is directed to an example of specifying the position of a customer from a video captured by the camera and performing correction considering the parallax according to the specified position. That is, the event other than a touch event is to acquire the video captured by the camera. As illustrated in FIG. 1, in Variation 2 of Embodiment 1, showcase 10 includes camera 13, and entire server 30 has image recognizer 38.

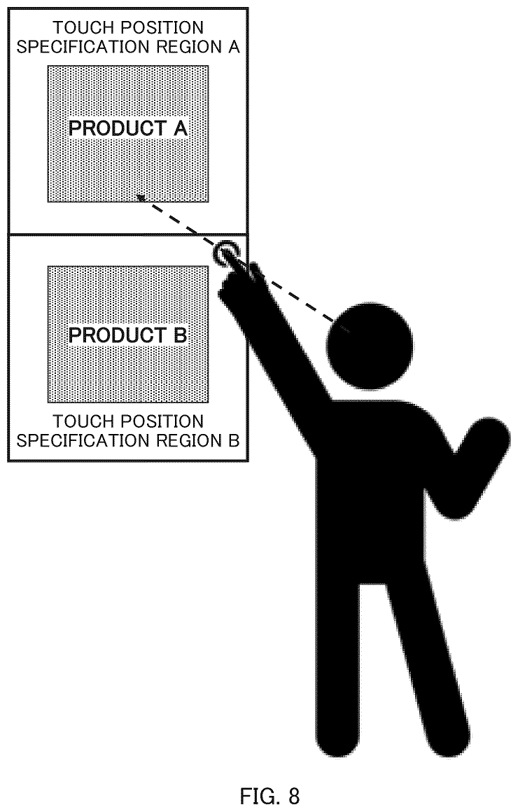

The parallax will be described with reference to FIG. 8. In adjacent touch position specification regions A and B on the screen, a problem may occur in which, although product A belonging to touch position specification region A is selected as seen from the line of sight of the customer, adjacent touch position specification region B is actually touched, and the information on product B is displayed instead of the information on product A that is desired. This may occur because the product displayed inside the showcase is spaced from transmissive touch display 11 and is placed at a position recessed as seen from the customer.

### (Camera 13)

A depth camera can be adopted as camera 13. The depth camera is a camera that can measure a distance (depth) to a target object, and while a normal 2D camera acquires a planar image, the depth camera can acquire “three-dimensional data” including physical distance information to the target object. As a result, the spatial positional relationship between the position of the eye of the customer and the fingertip that is touched can be understood. Further, a depth camera can be adopted as camera 13 for understanding the spatial positional relationship between the position of the eye of the customer and the fingertip that is touched on one hand and the product inside the showcase on the other. The depth camera is a camera that can measure a distance (depth) to a target object, and while a normal 2D camera acquires a planar image, the depth camera can acquire “three-dimensional data” including physical distance information to the target object. As a result, the spatial positional relationship between the position of the eye of the customer and the fingertip that is touched can be understood. Further, the spatial positional relationship between the position of the eye of the customer and the fingertip that is touched on one hand and the product inside the showcase on the other can be understood, for example, with reference to the frame of the showcase. Therefore, the position of the eye of the customer, the position of the fingertip that is touched, and the position of the product inside the showcase are obtained using a predetermined reference point of the frame of the showcase.

### (Image Recognizer 38)

Image recognizer 38 specifies a product on an extension of a line segment connecting the position coordinates of the eye of the customer and the touch position coordinates. When the product specified from the comparison between the position of the touch position specification region of touch position specification region information 63 and the touch position coordinates and the specified product on the extension line are the same, the correction due to the parallax is not performed. When the product specified from the comparison between the position of the touch position specification region of touch position specification region information 63 and the touch position coordinates and the specified product on the extension line are different, the original product information is not displayed, so that a correction instruction to perform the correction is output.

### Example 1 of Correction

Touch position manager 36 may obtain a correction amount (α, β) corresponding to a difference between a line segment connecting the position coordinates of the eye of the customer and the touch position coordinates and a line segment connecting the position coordinates of the eye of the customer and the touch position coordinates for the position coordinates (x, y) on the touched screen when the customer is assumed to view the product from the front, and add the correction amount (α, β) to the touch position coordinates (x, y) to generate corrected touch position coordinates (x+α, y+β) in response to the correction instruction.

Touch position manager 36 further compares the corrected touch position coordinates (x+α, y+β) with the coordinate range of the touch position specification region on the preset transmissive touch display 11 to specify to which region the corrected touch position coordinate (x+α, y+β) belongs. The processing is performed in the same manner as in Embodiment 1 using the corrected touch position coordinates (x+α, y+β).

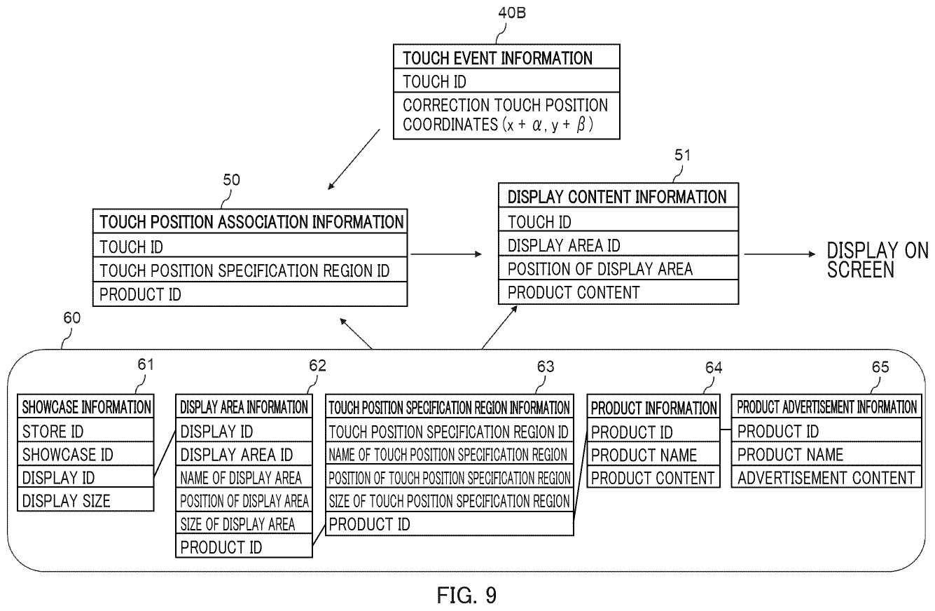

FIG. 9 is a diagram illustrating information used in displaying the product information on the screen using the corrected touch position coordinates (x+α, y+β) according to Example 1 of the correction. As is clear from FIG. 9, the difference from Embodiment 1 illustrated in FIG. 4 is that the corrected touch position coordinates (x+α, y+β) obtained by adding the correction amount (α, β) is also used as the touch position coordinates. The other points are the same as the processing of Embodiment 1.

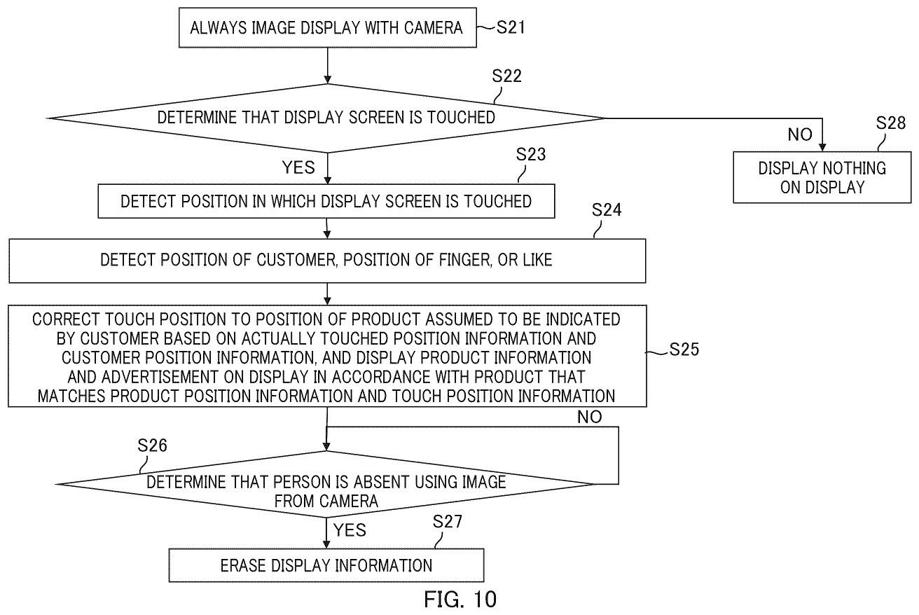

FIG. 10 is a flowchart illustrating a processing procedure in Variation 2 of Embodiment 1.

In Step S21, the camera is set to always image transmissive touch display 11.

In Step S22, the touch position recognizer determines whether transmissive touch display 11 is touched. When it is determined that a touch is performed, the processing proceeds to Step S23. When it is determined that a touch is not performed, the processing proceeds to Step S28.

In Step S23, the touch position determiner detects the actually touched position.

In Step S24, the image recognizer detects the position of a customer, the position of a finger, and the like, and transmits the detected information to the touch position determiner.

In Step S25, the touch position determiner corrects the touch position to the position of the product that is considered to be designated by the customer, based on the actually touched position information and the position information of the customer, and display determiner displays the product information and advertisement corresponding to the product that matches the product position information and the touch position information on the display.

In Step S26, the image recognizer determines whether there is a person in the image from the camera. When it is determined that there is a person, Step S26 is repeated. When it is determined that there is no person, the processing proceeds to Step S27.

In Step S27, the information on the display is erased.

In Step S28, nothing is displayed on the display.

For a planar showcase, the detection accuracy of the position of a finger of a customer or the like can be improved by installing a camera at a relatively high position.

Further, in correcting the touch position, a method of holding a table for correction and specifying the product from the table based on information, such as a standing position of the user and an orientation of the arm, can be used. As a result, the amount of calculation can be reduced. The table for correction holds correction data defined in advance based on information, such as the standing position of the user, the orientation of the arm, and the touched position. This table records a correction value based on a relative position between transmissive touch display 11 and the product or a past operation pattern of the user. The table for correction includes coordinate data (e.g., the position of the head or the arm detected by the camera) based on the line of sight of the customer or the orientation of the body, the angle or the position information of the arm when the user touches, and a correspondence relationship between the disposition of the product on transmissive touch display 11 and the actual position of the product. Examples thereof include correction history data collected in the past.

The coordinates for obtaining the correction amount may be two-dimensional or three-dimensional coordinates, and all three-dimensional coordinates can also be used. In the two-dimensional coordinate system, the position on the plane is represented by two axes of the X axis and the Y axis. For example, the touch position or the position of a product can be sufficiently represented by the two-dimensional coordinates. In the two-dimensional coordinate system, the calculation is simple, and the operation processing is light. In the three-dimensional coordinate system, in addition to the X axis and the Y axis, the Z axis is added, and the position in the entire space can be represented. When three-dimensional information such as a height or depth of transmissive touch display 11 or a sense of distance according to the standing position of the user is required, the three-dimensional coordinates are suitable. By adopting the three-dimensional coordinate system, handling the three-dimensional information makes it possible to correct the touch position more accurately based on the standing position of the user, the height of the viewpoint, and the distance. Further, when transmissive touch display 11 is large with respect to the height of the user or the user operates transmissive touch display 11 from different heights or angles, the operation can be performed more accurately by using the information of the Z axis (height). For example, when the customer views transmissive touch display 11 from different heights (tall person, child, or the like) or views transmissive touch display 11 at an angle, the touch position may deviate from the actual position on transmissive touch display 11. In order to correct this deviation, it is necessary to consider the height or the line of sight of the customer and the three-dimensional position information of the touched product. By using the three-dimensional coordinates, such a situation can be flexibly responded to.

Further, an incidence angle with respect to the head from the fingertip and the plane of the display can be used instead of the coordinates. The touch position of the product designated by the customer can be corrected based on the touch position and the incidence angle. The incidence angle refers to an angle formed between the fingertip of the user in a case of touching and the display surface. This angle is greatly affected by the position of the head of the user, the movement of the fingertip, the standing position, and the distance to the display. For example, when the user operates the display from front and when the user operates the display obliquely, there is a high possibility that a deviation occurs between the touch position and the product intended to be touched. In order to correct this deviation, the system understands the positional relationship from the head to the fingertip as the incidence angle and performs the correction based on the information.

Further, the distance information between the display and the product may hold a default value for the product of each showcase or may be manually input. Since the distance information varies depending on the design of the showcase or the disposition of the product, a default value set in the system in advance can be used. This default value is optimized for each showcase model and is automatically applied in normal operation. For example, in a specific showcase, since the distance between the display and the product shelf is constant, the touch position can be corrected with high accuracy by using the default value set in advance. Meanwhile, in some cases, the default distance setting may not be suitable depending on the design of the store or the layout of the product. In such a case, the distance information can also be manually input. For example, when a specific product is displayed deeper than other products or a special product layout is adopted, the correction can be optimized by manually adjusting the distance information by the staff member such that the customer can accurately select the product.

According to Variation 2 of Embodiment 1, the problem of selecting a product different from the intended product due to the parallax when the position of the product visible through transmissive touch display 11 is touched by the customer can be solved. Specifically, accurately understanding the position of the eye of the customer and the touch position with the camera and performing the parallax correction based on the positional relationship makes it possible to accurately display the product information that the customer actually desires to select. Even in an environment in which the product is spaced from transmissive touch display 11 or the product is displayed at a deep position of the showcase, the accurate operation can be ensured in any installation situation by using the parallax correction function. Since the parallax problem is effectively functioned even in an installation environment in which the parallax problem is significant, application to a wide range of showcases is possible. By using the depth camera to three-dimensionally recognize the position of the eye of the customer and the touch position and realizing high-accuracy parallax correction, the operation of the customer becomes more intuitive and comfortable. As a result, the customer can smoothly acquire the product information or the advertisement without worrying about an erroneous operation, so that the operation experience of the showcase is improved. As described above, minimizing the influence of the parallax and accurately displaying the product information intended by the customer makes it possible to realize a system that provides a comfortable operation experience. Furthermore, since the opening and closing of the door is suppressed and the inside temperature of the cold equipment, such as the showcase in which the product is stored is suppressed from increasing, the energy saving performance can be improved.

### Variation 3 of Embodiment 1

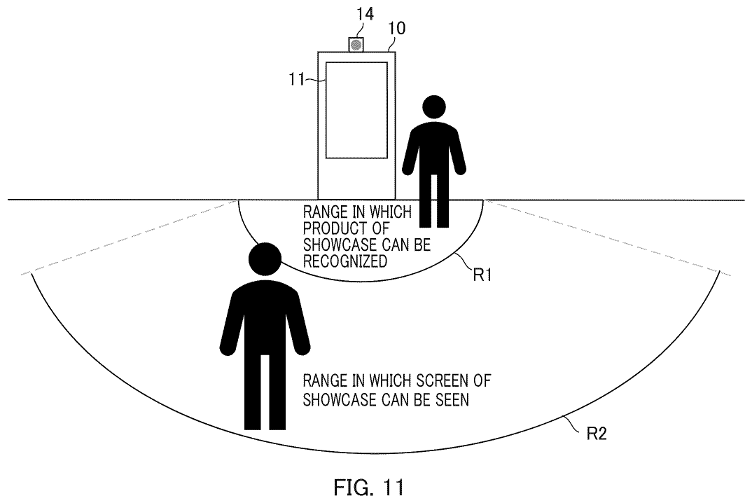

Variation 3 of Embodiment 1 will be described. Variation 3 of Embodiment 1 is directed to an example of switching the display mode of the display according to the position of a customer. Showcase 10 according to Variation 3 includes position detection camera 14 for detecting the position of a customer, as illustrated in FIG. 11. Variation 3 of Embodiment 1 will be described. Variation 3 of Embodiment 1 is directed to an example of switching the display mode of the display according to the position of the customer.

### (Position Detection Camera 14)

Position detection camera 14 is installed in showcase 10 to accurately detect the position of a customer. Position detection camera 14 is installed at an appropriate position of the upper part or the periphery of showcase 10 to monitor the movement or the position of the customer in front of the showcase. The installation angle of position detection camera 14 is adjusted to be capable of understanding the entire showcase and can capture the entire body of the customer in front of the showcase. Position detection camera 14 has a wide angle of view (e.g., 120 degrees or more) and can cover a wide range in front of the showcase. As a result, the movement of a plurality of customers can be detected at the same time. The resolution of position detection camera 14 is, for example, HD (1280×720) or higher, and the posture, the orientation of the face, the line of sight, and the like of the customer can also be captured in detail. Position detection camera 14 detects the position of the customer in real time and transmits the data to image recognizer 38. Position detection camera 14 may be equipped with a line-of-sight detection function or a face recognition function and may also detect whether the customer is paying attention to the showcase or the display.

### (Image Recognizer 38)

Entire server 30 has image recognizer 38. Image recognizer 38 estimates the distance between the customer and showcase 10 based on the video or the image captured by position detection camera 14, with a predetermined position (e.g., the center of the lower part of showcase 10) of showcase 10 as a reference. Image recognizer 38 calculates the distance between the reference point of showcase 10 and the position of the customer based on the imaging data of position detection camera 14. In the calculation of the distance, an angle of view or a focal length of position detection camera 14 and the position (coordinate) of the customer on the image are used. The distance is estimated based on the position coordinates (x, y, z) of the customer in the angle of view of position detection camera 14. First, image recognizer 38 identifies a specific part of the body of the customer, for example, a head, a shoulder, or a trunk, from the video captured by position detection camera 14. As a result, the center point of the body of the customer is calculated, and the position of the center point in the image is detected. Subsequently, the distance to the customer is calculated, for example, using a triangulation method based on the information on the focal length and the angle of view of position detection camera 14 and the relative positional relationship from the reference point of showcase 10 on which position detection camera 14 is installed.

When the customer is moving, the movement direction or the speed of the customer can be analyzed using the image data of a plurality of frames, and the distance can be estimated with higher accuracy. Specifically, the movement speed is calculated by dividing the amount of change in the position coordinates of the customer by time, and the distance to showcase 10 is corrected in real time. Further, it is also possible to use a plurality of cameras to integrate the imaging data from different angles and to estimate the three-dimensional position of the customer with high accuracy.

Image recognizer 38 sets range R2 in which the customer can see the screen of showcase 10 and range R1 in which the customer can recognize the product placed in showcase 10, with respect to the estimated distance. Ranges R1 and R2 can be set, for example, according to the estimated distance, the height of the customer, the height and the size of the showcase, the resolution and the size of the display, the line of sight or the orientation of the face of the customer, the ambient environmental light, and the like. The boundary line of ranges R1 and R2 may be set to be concentric circles or may be set to be an ellipse, a quadrangle, a polygon, or a side or a part thereof.

The distance from showcase 10 to the customer is the most basic parameter in a case of determining the settings of R1 and R2. When the distance is short, R1 is set to be small, and the range in which the product can be directly checked is widened. On the contrary, when the distance is long, R2 is set to be wide, and the visibility of the product or the advertisement on the screen is prioritized.

The angle of view of position detection camera 14 may be necessary to accurately understand the position of the customer. When the angle of view is wide, the ranges of R1 and R2 are also widened, so that the movement or the line of sight of the customer who is farther away can be recognized.

The height of the customer is a parameter for determining a range of a height at which the screen or the product can be visually recognized. In particular, when the height is low, R1 and R2 need to be adjusted to be small. The height of the customer can use the disclosure of Variation 1 of Embodiment 1.

The dimensions (height, width) of showcase 10 directly affect the calculation of R1 and R2. This is because the position from which the product or the screen is visible is determined according to the height of the showcase. For example, when the showcase is high, R1 and R2 need to be appropriately set according to the line of sight or the height of the customer.

The resolution or the size of the display also affects R2. For a display having a high resolution, detailed information on the product or the advertisement can be easily seen from a distance, and R2 can be set to be large. Meanwhile, when the resolution is low or the display is small, the information can be recognized only when the customer is close, so R2 is set to be small.

By using the line-of-sight detection or the face orientation detection, it is possible to determine in which direction the customer is looking and to adjust the application ranges of R1 and R2. For example, when the customer does not face the showcase, R2 is widened, and the visible range can be automatically adjusted.

The brightness of the environmental light can also be considered. When the surroundings are too bright or too dark, the settings of R1 and R2 can be adjusted. When the environmental light of surroundings is adopted as a parameter, a photometer may be provided in showcase 10.

Image recognizer 38 recognizes the position of a customer from the image of the position detection camera and determines whether the customer is present in the “range R2 in which the customer can see the screen of showcase 10” or the “range R1 in which the customer can recognize the product placed in showcase 10” based on the set ranges R1 and R2. Display determiner 37 outputs a command to switch between the advertisement mode and the transmissive mode to display manager 22 of display controller 20 in response to the determination of image recognizer 38. Transmissive touch display 11 switches and displays the advertisement mode and the transmissive mode in response to the switching command.

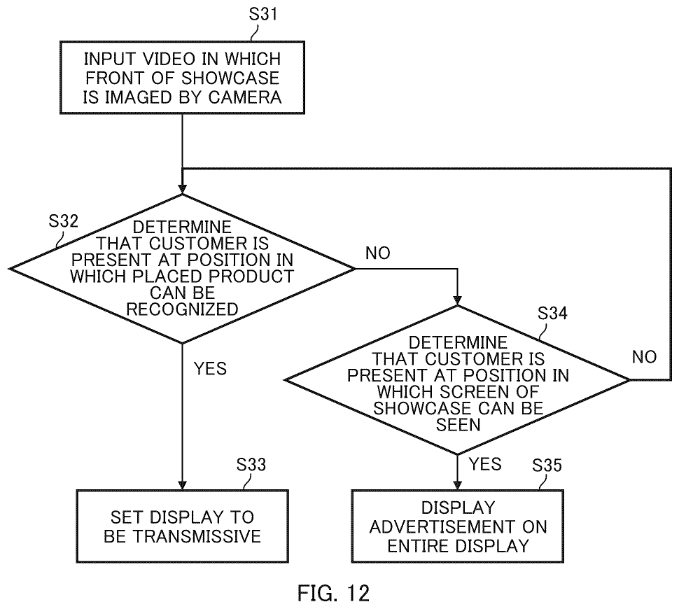

FIG. 12 is a flowchart illustrating a processing procedure of Variation 3 of Embodiment 1.

In Step S31, image recognizer 38 inputs the video from position detection camera 14.

In Step S32, image recognizer 38 determines whether the customer is in range R1 in which the product placed in showcase 10 can be recognized. When it is determined that the customer is in range R1 in which the product placed in showcase 10 can be recognized, the processing proceeds to Step S33. When it is determined that the customer is not in range R1 in which the product placed in showcase 10 can be recognized, the processing proceeds to Step S34.

In Step S33, transmissive touch display 11 of showcase 10 is set to the transmissive mode.

In Step S34, it is determined whether the customer is in range R2 in which the screen of showcase 10 is visible. When it is determined that the customer is in range R2 in which the screen of showcase 10 is visible, the processing proceeds to Step S35. When it is determined that the customer is not in range R2 in which the screen of showcase 10 is visible, the processing returns to Step S32.

In Step S35, the display mode of the display is set to the advertisement mode.

A human sensor for a distance and a human sensor for a short distance may be used instead of position detection camera 14. As a result, it is easy to determine that a person is close by. Further, after the display content is changed, it is not necessary to perform the next determination for a while. Specifically, the timer is activated at a point in time when the display mode (advertisement mode and transmissive mode) of the display is switched, and the new customer position determination by image recognizer 38 is temporarily stopped until, for example, several seconds to several tens of seconds (time according to the situation) elapse. As a result, the frequency of switching the screen can be reduced, and the burden on the customer is reduced.

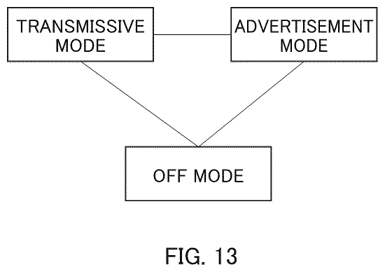

As illustrated in FIG. 13, the switching to the transmissive mode is performed from the advertisement mode or the off mode, and the switching to the advertisement mode is performed from the transmissive mode or the off mode. When position detection camera 14 (or human sensor) does not detect a person for a predetermined period, the mode may be switched from the advertisement mode or the transmissive mode to the off mode. As a result, unnecessary power can be reduced, and the energy saving performance can be improved.

According to Variation 3 of Embodiment 1, when the customer is far from the showcase, the display is automatically switched to the advertisement mode, and the product is displayed to the customer in a large and emphasized manner. In this case, by making basic information or features of the product conspicuous, a visual impact can be given to the customer, and it is possible to clearly suggest what kind of product is in the showcase. As a result, the customer can develop interest in the showcase and obtain a motivation to get closer. Meanwhile, when the customer approaches the showcase, the display is switched to the transmissive mode, and the product can be directly seen through the transmissive display. In this transmissive mode, the customer can check the actual product in detail, so that deeper interest or purchase intention can be aroused by seeing the actual product. The switching between the transmissive mode and the advertisement mode is automatically performed based on the camera or the sensor that detects the position or the movement of the customer in real time, and the optimal information display is always performed for the customer.

### Variation 4 of Embodiment 1

Variation 4 of Embodiment 1 is directed to an example of determining the interest of the customer in the product by detecting the line of sight or the movement line of the customer and switching the display mode in response to the determination and a determination as to whether there is another customer in a range detected by the camera. The showcase according to Variation 4 has a line-of-sight movement line detection camera for detecting the line of sight or the movement line of the customer. The line-of-sight movement line detection camera can be disposed at the same position as camera 13 of Variation 1 of Embodiment 1 illustrated in FIG. 6A. Further, for example, the line-of-sight movement line detection camera can be used in common with camera 13 of Variation 1 of Embodiment 1 illustrated in FIG. 6A.

The line-of-sight detection is to specify where the customer is looking. For the line-of-sight detection, for example, a camera (e.g., an infrared camera) that captures the movement of the face or the eye of the customer can be used as the line-of-sight movement line detection camera. This camera can track the orientation of the face of the customer or the movement of the pupil in real time and determine whether the line of sight is directed to transmissive touch display 11 or the product. In addition to the camera, image recognizer 38 may calculate the line-of-sight direction by using a face detection algorithm and a pupil detection algorithm. Image recognizer 38 may further process the image data from the camera to estimate the line-of-sight direction from the position of the pupil or the orientation of the face and determine whether the customer is looking at the product or the advertisement through transmissive touch display 11. Furthermore, the movement of the pupil may be detected by using infrared rays. Since the infrared sensor is less affected by external light and can accurately detect the line of sight, stable results can be obtained even in a place where the illumination condition is unstable. The image processing by the camera and/or the infrared sensor is executed by image recognizer 38.

The movement line detection is a means for tracking the movement of the customer and measuring the interest level of the product based on the movement line. Using the line-of-sight movement line detection camera to track the movement trajectory of the customer makes it possible to detect from which direction the customer approaches the showcase or which product the customer stays for a long time. A plurality of cameras may be installed as the line-of-sight movement line detection camera to track the movement of the customer from different angles, thereby three-dimensionally detecting the movement line of the customer. As a result, it is possible to determine how the customer is moving around the showcase. Furthermore, image recognizer 38 may analyze the video data obtained by the line-of-sight movement line detection camera by AI to learn the movement or the behavior pattern of the customer. The AI can analyze information such as in front of which product the customer has stopped or in from of which specific product the customer has stayed for a long time, and estimate the interest level. The processing related to the movement line detection is executed by image recognizer 38.

The interest level estimation parameter for estimating the interest level of the customer includes at least one of a gaze duration with respect to the display, a gaze frequency of the person toward the display screen, a stagnation time of the customer, an approaching speed of the customer, a movement direction of the customer, or a change in facial expression of the customer. By individually or comprehensively analyzing the interest level estimation parameter, the interest level of the customer can be estimated with high accuracy, and the display mode can be switched to the optimal display mode.

The gaze duration with respect to the display is obtained by measuring how long the line of sight of the customer is retained on a specific product or an advertisement on the display based on the line-of-sight detection. The longer the gaze duration is, the more likely it is that the customer is interested in the product.

The gaze frequency of the person toward the display screen is obtained by measuring the number of times the customer returns the line of sight to the same product or advertisement a plurality of times. The larger the number of times is, the higher the interest is estimated to be. In particular, when the line of sight is once away and then focused again, it is suggested that the interest level is high.

The stagnation time of the customer is obtained by measuring how long the customer stays in front of the showcase at a specific product or area. When the movement line stagnates for a long time in front of a specific product or area, it is determined that the interest in the product is high.

The approaching speed of the customer is obtained by measuring how fast the customer approaches the showcase. When the customer quickly approaches the showcase, there is a possibility that the interest or the purchase intention is high. On the contrary, when the approach is slow or the customer stops temporarily, the interest level may be low.

The movement direction of the customer is obtained by tracking from which direction the customer approaches the showcase and detecting in which direction the customer is facing when passing in front of a specific product. As a result, it is possible to understand which range of products the customer is particularly interested in.

The change in the facial expression of the customer is obtained by analyzing the facial expression of the customer by the face detection algorithm. When a positive facial expression change, such as a smile or a movement of the eyebrows is observed, it can be estimated that there is a favorable reaction to the product.

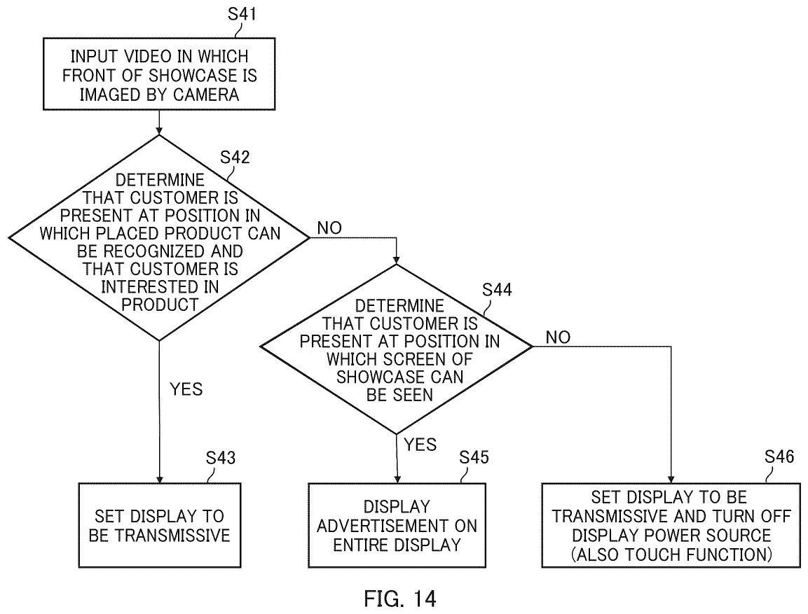

FIG. 14 is a flowchart for describing a processing procedure according to Variation 4 of Embodiment 1.

In Step S41, image recognizer 38 inputs a video from a line-of-sight movement line detection camera.

In Step S42, image recognizer 38 determines whether the customer is in a position where the product displayed in the showcase can be recognized based on the video from the line-of-sight movement line detection camera. Furthermore, image recognizer 38 determines whether the customer is interested in the product displayed in the showcase based on the interest level estimation parameter.

When it is determined that there is interest as a result of the determination, the processing proceeds to Step S43. When it is determined that there is no interest, the processing proceeds to Step S44.

In Step S43, the display is switched to the transmissive mode so that the customer can visually recognize the product.

When it is determined in Step S44 that the customer is in a position where the screen of the showcase is visible, the processing proceeds to Step S45. When it is not determined that the customer is in a position where the screen of the showcase is visible, the processing proceeds to Step S46. Since Step S44 of Variation 4 of Embodiment 1 is the same as Step S34 of Variation 3 of Embodiment 1, the details thereof will be omitted.

In Step S45, the display is set to the advertisement mode.

In Step S46, the display is set to the off mode in which the display is set to the transmissive mode and the display power is turned off.

According to Variation 4 of Embodiment 1, even when the customer is near the showcase, when the customer is not interested in the product, the advertisement is transmitted to another customer who is far away to the extent that the customer can see the showcase, so that the attractiveness of the showcase can be maximized. According to Variation 4 of Embodiment 1, the interest level of the product can be automatically determined by detecting the line of sight or the movement line of the customer, and the display mode can be optimally switched. With this mechanism, the display of the showcase is dynamically changed based on the behavior of the customer, so that the following effects are obtained. Since the display is switched to the transmissive mode only when the customer is actually interested, it is possible to reduce unnecessary information display. When the customer does not show interest in the product, the advertisement mode is switched to target another customer who is far away, and the product or the service can be effectively promoted. As a result, the showcase continues to function as an advertising medium, and effective advertisement display is realized. When it is determined that the customer is not interested in the showcase or the display based on the movement line or the line of sight, the power of the display can be turned off to reduce unnecessary energy consumption. As a result, an energy saving effect that is environmentally friendly can also be expected. Using AI or image processing technology to track the movement line or the line of sight of the customer and analyzing the interest level makes it possible to understand the behavior pattern of the customer. As a result, data that can be used to optimize the marketing strategy or improve the future product disposition or the advertising strategy can be obtained. Since the display switching corresponding to the behavior of the individual customer can be performed by the line-of-sight detection or the movement line detection, even in a situation where a plurality of customers are using the showcase at the same time, the display can be performed according to the interest of each customer, and more flexible response can be made.

### Variation 5 of Embodiment 1

Variation 5 of Embodiment 1 is directed to an example of switching the display to the transmissive mode, the advertisement mode, or the off mode according to the position of a customer. Since the configuration of Variation 5 of Embodiment 1 is the same as that of Variation 3 of Embodiment 1, the detailed description thereof will be omitted.

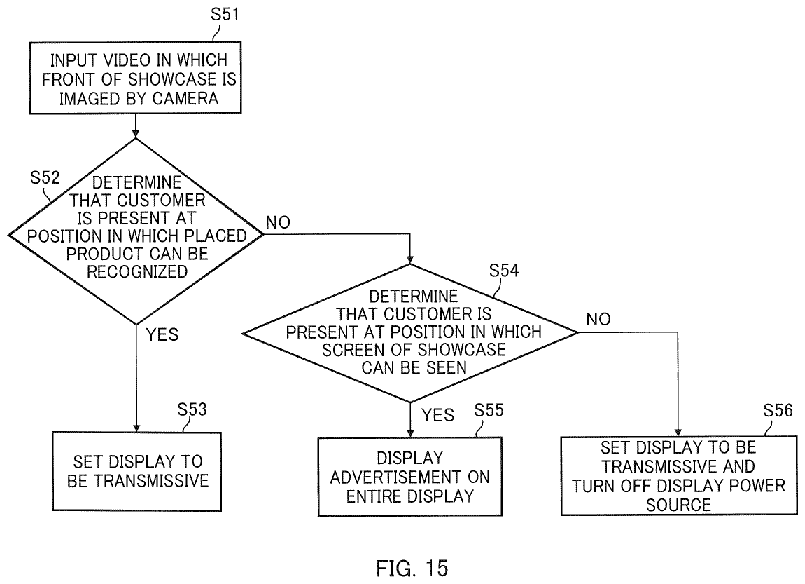

FIG. 15 is a flowchart for describing a processing procedure of Variation 5 of Embodiment 1.

In Step S51, image recognizer 38 inputs a video from camera 13.

In Step S52, image recognizer 38 determines whether the customer is in range R1 in which the product placed in showcase 10 can be recognized. When it is determined that the customer is in range R1 in which the product placed in showcase 10 can be recognized, the processing proceeds to Step S53. When it is determined that the customer is not in range R1 in which the product placed in showcase 10 can be recognized, the processing proceeds to Step S54.

In Step S53, transmissive touch display 11 of showcase 10 is set to the transmissive mode. As a result, the customer determined to be in range R1 can recognize the product placed in showcase 10 through transmissive touch display 11 that is transparent.

In Step S54, it is determined whether the customer is in range R2 in which the screen of showcase 10 is visible. When it is determined that the customer is in range R2 in which the screen of showcase 10 is visible, the processing proceeds to Step S55. When it is determined that the customer is not in range R2 in which the screen of showcase 10 is visible, the processing proceeds to Step S56.

In Step S55, the display mode of the display is set to the advertisement mode. As a result, the customer determined to be in range R2 can see the advertisement displayed on transmissive touch display 11.

In Step S56, the display is transitioned to the off mode in which the display is set to be transparent and the display power is turned off. As a result, it is possible to suppress power consumption while the display is in a transparent state.

According to Variation 5 of Embodiment 1, the energy efficiency can be improved by flexibly switching the display to the three modes of the transmissive mode, the advertisement mode, and the off mode according to the position of the customer. When the customer is in a position where the product or transmissive touch display 11 cannot be recognized, the power of the display is turned off, so that unnecessary energy consumption can be minimized. As a result, the overall energy efficiency is improved, and the environmental load can be reduced. When the customer is in a range (R1) in which the customer is interested in the product and can check the product, that is, a range in which the product is visible when the line of sight is directed, the display is switched to the transmissive mode, so that the customer can directly check the product. As a result, the attractiveness of the product can be maximally conveyed to the customer visually, and an effect of promoting the purchase intention is expected. When the customer does not show interest in the product or is away from the product, the display can be switched to the advertisement mode to effectively display the advertisement. As a result, the showcase is not only used as a simple product display but also used as an advertising medium, and the effect of promoting the product or the service can be maximized. Since the display is dynamically changed according to the position or the operation of the customer, the most suitable information for the customer can be provided at an appropriate timing. As a result, the customer experience is improved, and an effect of making the customer interested in the showcase itself can be expected. Further, by avoiding unnecessary display or information complexity, the stress of the customer can be reduced. By automatically detecting the position of the customer and switching the display mode in response to the position, the operation of the showcase is improved in efficiency. As a result, it is not necessary for the store staff to manually operate or adjust, which also leads to the efficiency of the work.

### Variation 6 of Embodiment 1

Variation 6 of Embodiment 1 is directed to an example of including a first camera that images a remote position and a second camera that images a nearby position with respect to showcase system 1 of Embodiment 1.

The showcase system according to Variation 6 of Embodiment 1 includes a first camera that images a remote position and a second camera that images a nearby position.

### (First Camera)

The first camera images a remote position with respect to the showcase. The first camera is specialized in imaging a remote customer in front of the showcase and mainly covers a wide area. As a result, it is possible to detect how much interest the customer who is far away has in the showcase and whether the customer is approaching the showcase. The first camera can capture a customer who is in a range of several meters or more away from the showcase. Even in a situation where a plurality of customers is simultaneously visually recognized, it is possible to capture the movement of each customer because the angle of view is wide. The first camera captures the orientation or the posture of the face of the customer and determines whether the customer is looking at the showcase. As a result, it is possible to determine whether the customer is interested in the showcase.

### (Second Camera)

The second camera images a nearby position with respect to the showcase. The second camera is specialized in capturing a nearby customer who is near the showcase and plays a role of detecting the movement or the line of sight of the customer who is directly interested in the product. The second camera detects a fine movement or an orientation of the face of the customer when the customer is near the showcase. As a result, it is possible to understand whether the customer is looking at the product or transmissive touch display 11 of the showcase or is staying nearby. The second camera tracks the orientation of the face of the customer or the line of sight and determines in real time whether the customer is looking at the product or transmissive touch display 11 of the showcase.

### (Image Recognizer 38)

Image recognizer 38 is configured to analyze the video data collected from the two cameras. The first camera images a remote position, that is, the overall movement of the customer before the customer approaches transmissive touch display 11 or the showcase, and the second camera images a nearby position, that is, the detailed movement of the customer when the customer approaches the showcase. The data acquired from these cameras can be individually analyzed, and by independently analyzing the movement of the remote and the nearby, the behavior of the customer from the stage at which the customer starts to be interested in the showcase to the stage at which the customer actually selects the product can be analyzed by sequentially tracking the change in the movement or the line of sight of the customer and analyzing the change in the interest level. On the other hand, by complementarily analyzing these data, the behavior pattern of the customer can be more three-dimensionally captured. By associating the movement from a distance with the information on the line of sight or the touch operation nearby, it is possible to analyze how the product or the advertisement that the customer first showed interest in affected the subsequent behavior of the customer. As described above, by combining the data acquired from different distances by the two cameras, it is possible to perform more detailed and accurate behavior analysis.

The data acquired by these cameras is analyzed by using AI or advanced image processing technology. The AI learns the behavior pattern based on the data of the movement or the line of sight of the customer and understands the degree of interest in the showcase or the display. For example, it is possible to analyze in detail information such as which part of the display the customer is looking at, how long the customer maintains the line of sight, or at what timing the customer performs the touch operation. As a result, it is possible to quantitatively evaluate how the product in which the customer is interested or the specific advertisement affects the behavior of the customer.

By using the AI and the image processing technology, it is possible to understand the behavior pattern or the interest level of the customer in more depth. For example, when the customer tends to approach the showcase from a distance and focus the line of sight on a specific product, it is likely that the advertisement or the information of the product is effectively functioning. Further, by analyzing the detailed line-of-sight data or the touch motion at the nearby position, it is also possible to determine whether the customer is actually considering a purchase or is merely interested.

Furthermore, by the complementary analysis of combining the data at the remote and the nearby, for example, based on the movement or the speed of the customer when approaching from a distance, or the behavior and the change in the line of sight after the approach, it is possible to estimate the interest level or the purchase intention of the customer. By analyzing in detail how the customer approaches from a distance, at what point the interest is generated, and what decision is finally made, it is possible to optimize the disposition of the showcase or the advertisement display in the future.

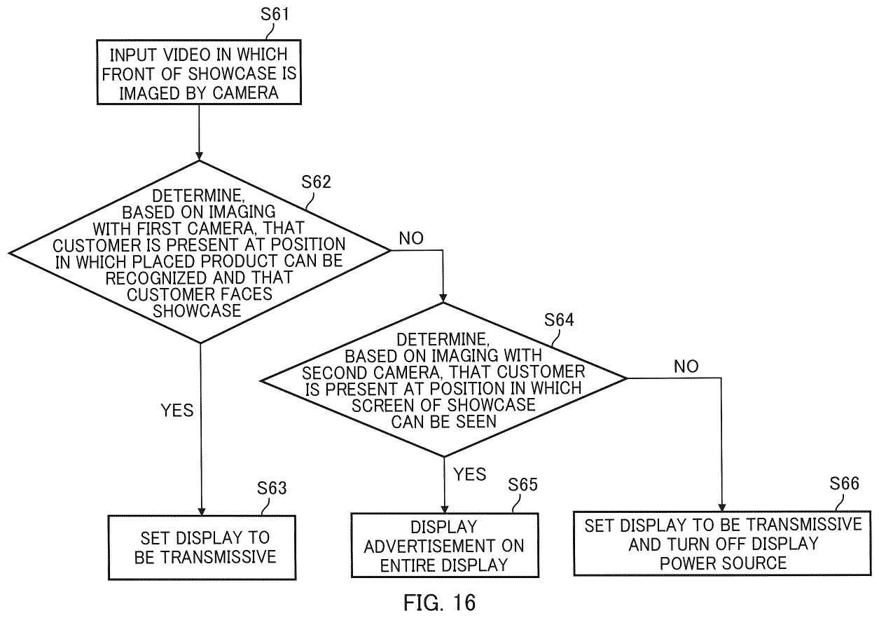

FIG. 16 is a flowchart for describing a processing procedure of Variation 6 of Embodiment 1.

In Step S61, the video in which the front of the showcase is imaged using the first camera and the second camera is input to image recognizer 38.

In Step S62, image recognizer 38 determines that the customer is in a position where the product can be recognized and that the customer is facing the showcase based on the imaging of the first camera. When the determination result is Yes, the processing proceeds to Step S63. When the determination result is No, the processing proceeds to Step S64.

In Step S63, image recognizer 38 outputs a command to set the display to the transmissive mode.

In Step S64, image recognizer 38 determines whether the customer is in a position where the screen of the showcase is visible based on the imaging of the second camera. When the determination result is Yes, the processing proceeds to Step S65. When the determination result is No, the processing proceeds to Step S66.

In Step S65, image recognizer 38 outputs a command to set the display to the advertisement mode.

In Step S66, image recognizer 38 outputs a command to set the display to the transmissive mode and to set the display to the off mode in which the display power is turned off.

By dividing the two cameras that recognize the customer, the detection range can be widened.

According to Variation 6 of Embodiment 1, by combining the first camera and the second camera, the movement of the remote and nearby customers can be more accurately detected. As a result, the movement or the line of sight of the customer can be accurately understood, and the switching to the optimal mode in response to the movement or the line of sight can be performed. Specifically, it is possible to accurately determine whether the customer who is far away is interested in the showcase or the customer who is near is actually checking the product. When the remote customer is interested in the showcase by the first camera, the advertisement mode is triggered, and the product can be effectively promoted to the customer. By switching to the advertisement mode, it is possible to display an advertisement that has a large impact on the customer, and the showcase itself functions as a dynamic advertising medium. When the customer approaches the showcase and shows interest in the product, the second camera detects the customer, and the mode is switched to the transmissive mode. By the transmissive mode, the customer can visually recognize the actual product through transmissive touch display 11 and can directly check the attractiveness of the product. As a result, an effect of increasing the purchase intention of the customer by exhibiting the actual product is expected. By using the two cameras, the movement of a plurality of customers can be tracked at the same time, and even when a plurality of customers are at different positions, it is possible to provide the optimal display mode for each of the customers. For example, by switching to the advertisement mode for the remote customer and switching to the transmissive mode for the nearby customer, it is possible to respond to the diverse customers in front of the showcase, and the customer experience is improved. When the customer does not show interest in the showcase or does not approach the product, the display is set to the off mode, so that unnecessary energy consumption can be suppressed. As a result, an energy saving effect is expected, which also leads to environmental consideration and reduction of operating costs. Since the display is not always displayed and is switched to the advertisement mode, the transmissive mode, or the off mode as necessary, the usage time of the display is optimized, and the long-term durability is also improved. As a result, the wear of the display can be suppressed, and the reduction of the maintenance frequency and the cost can also be expected. The data on the movement or the line of sight of the customer collected by the two cameras is analyzed by using the AI or the image processing technology, so that the behavior pattern or the interest level of the customer can be accurately understood. As a result, it is possible to use the information for optimizing the future marketing strategy, the product disposition, or the advertisement content.

### Variation 7 of Embodiment 1: Registration Mode of Product

Variation 7 of Embodiment 1 is an example directed to a registration mode for registering a product (hereinafter, may be referred to as “product registration mode”) in the touch position specification region information in a situation where the product of showcase 10 is replaced with another product, and the components are the same as those illustrated in FIG. 1.

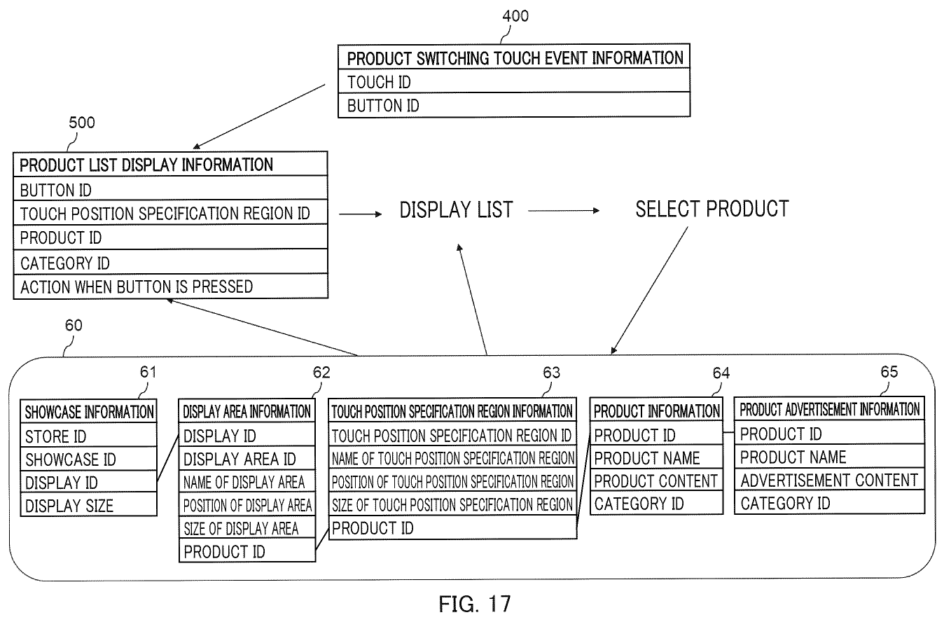

Variation 7 of Embodiment 1 will be described with reference to FIG. 17. FIG. 17 is a diagram illustrating information used in displaying the product information on the screen in response to a replacement button.

### (Transition of Transmissive Display to Registration Mode of Product)

The switching from the transmissive mode, the advertisement mode, or the off mode to the product registration mode is performed by using, for example, the display controller or store terminal 4 installed in the store, a tablet or a smartphone, a physical button provided in the showcase, a menu button on transmissive touch display 11 including the display, or the like. In a case of store terminal 4, a tablet, or a smartphone, the switching instruction to the product registration mode performed by using a physical button or a menu button on the display is received by external device cooperator 35 and is input to display determiner 37. Further, in a case of the showcase, the switching instruction to the product registration mode performed by using a menu button on transmissive touch display 11 is received by touch position recognizer 21 of display controller 20 and is input to display determiner 37. In the product registration mode, in order to make the product inside the showcase visible from the outside, first, the entire transmissive touch display 11 is set to the transmissive mode, and the display of information necessary for the product registration, such as a replacement button and the product name, is performed for each of the touch position specification regions on the screen.

### (Display Determiner 37: Display of Replacement Button)

Display determiner 37 outputs a command to display the replacement button for each of the touch position specification regions on the screen to transmissive touch display 11 in response to the transition event from the display mode to the product registration mode. In response to the replacement button display command, transmissive touch display 11 displays product replacement button X and the product name in the touch position specification region for each of the touch position specification regions on the screen.

The replacement button display command is generated from, for example, the replacement button display information indicated in Table 12. With reference to the first row of Table 12, the button A (button ID: Button_A) is displayed at a button display position (50, 50) to (200, 100) in touch position specification region A, the product name (product X) is displayed at a product name display position (250, 150) to (400, 250), the button A is for replacing product X (product ID: Product_X) of touch position specification region A (touch position specification region ID: Region_A) with another product, and pressing button A displays the product list.

TABLE 12

| | | | | | | Name of | | |
|---|---|---|---|---|---|---|---|---|
| | | | Product | | Touch | touch | | |
| | | Button | name | Action when | position | position | | |
| | Button | display | display | button is | specification | specification | | Product |
| Button ID | name | position | position | pressed | region ID | region | Product ID | name |
| Button_{—} | Button | (50, 50)~ | (250, 150)~ | Generate | Region_A | Touch | Product_{—} | Product |
| A | A | (200, 100) | (400, 250) | product list | | position | X | X |
| | | | | in accordance | | specification | | |
| | | | | with | | region A | | |
| | | | | Category ID | | | | |
| Button_{—} | Button | (550, 50)~ | (750, 150)~ | Generate | Region_B | Touch | Product_{—} | Product |
| B | B | (700, 100) | (900, 250) | product list | | position | Y | Y |
| | | | | in accordance | | specification | | |
| | | | | with | | region B | | |
| | | | | Category ID | | | | |
| Button_{—} | Button | (350, 350)~ | (550, 450)~ | Generate | Region_C | Touch | Product_{—} | Product |
| C | C | (500, 400) | (650, 550)~ | product list | | position | Z | Z |
| | | | | in accordance | | specification | | |
| | | | | with | | region C | | |
| | | | | Category ID | | | | |

### (Touch Position Recognizer 21: Detection of Touch of Button)

Touch position recognizer 21 specifies the touched button based on the replacement button display information.

### (Touch Position Manager 36: Product Replacement Touch Event Information 400)

Touch position manager 36 generates product replacement touch event information 400 related to the product replacement touch event according to the button specified by touch position recognizer 21. “Product replacement touch event information 400” is composed of, for example, as indicated in Table 13, a touch ID set to identify the product replacement touch event and a button ID on the touched screen.

TABLE 13

| Touch ID | Button ID |
|---|---|
| Touch_1 | Button_A |

Touch position manager 36 generates product list display information 500 that associates product replacement touch event information 400 with replacement button display information 66. Product list display information 500 is composed of, for example, as indicated in Table 14, a touch ID, a button ID, a touch position specification region ID, a product ID, a category ID, an action when the button is pressed, and a display form of the list.

TABLE 14

| | | Touch position | | | | Display |
|---|---|---|---|---|---|---|
| | | specification | | | Action when button | form of |
| Touch ID | Button ID | region ID | Product ID | Category ID | is pressed | list |
| Touch_1 | Button_A | Region_A | Product_X | Category_1 | Cr product list in | List view |
| | | | | | accordance with | format |
| | | | | | Category ID | |

### (Display Determiner 37: Display of Product List)

Display determiner 37 generates a product list according to product list display information 500 from touch position manager 36 and instructs the display to display the product list. In a case of the example of Table 7, it is indicated that the product list of the product belonging to category 1 is generated as the product list and is displayed in a list view format.

When the user selects one product from the product list displayed on the screen, the information of touch position specification region information 63 is rewritten.

### (Registration Mode of Product)

A case where product A is replaced with product B will be described as an example, and the processing of each component in the product registration mode will be described. For brevity of description, the area, the command, and the product list related to product A are labeled with the character, A.

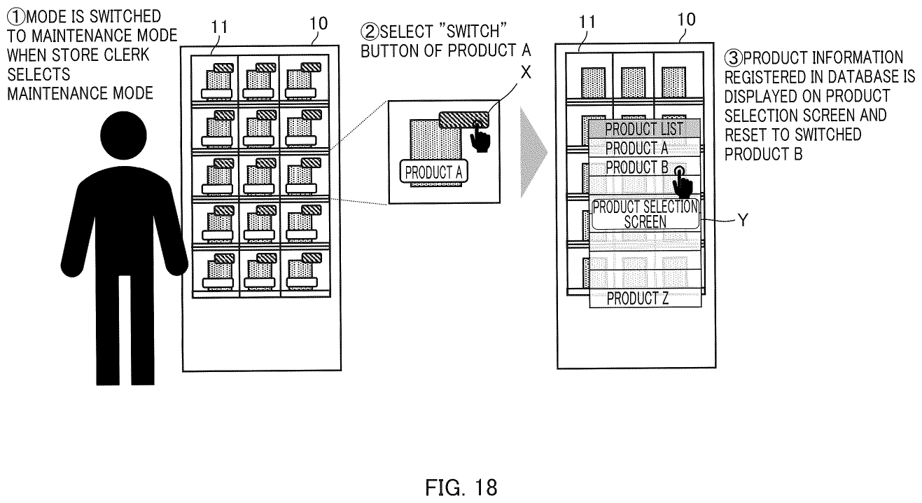

FIG. 18 is a diagram illustrating an example of a screen of a replacement button displayed on the display in a case of replacing product A with product B and a product list. A procedure of replacing product A with product B will be described with reference to FIG. 18. When a store clerk switches to the product registration mode, which is one of the maintenance modes, the product replacement button and the product name are displayed in each of the touch position specification regions on transmissive touch display 11. In this case, display determiner 37 controls the transmittance of the display portion of product replacement button X or product list Y to be displayed in a semi-transmissive state in which the inside of the showcase or the product stored in the showcase can be visually recognized through these buttons or the list. Therefore, the store clerk can visually recognize the product behind transmissive touch display 11 through these buttons or the list. The term “semi-translucent” is not limited to a transmittance of 50% and is any transmittance greater than 0% and less than 100%. Therefore, the store clerk can visually recognize the product behind transmissive touch display 11. When the store clerk presses product replacement button X related to product A, product list Y is displayed in response to the pressing. The store clerk selects product B after the replacement from product list Y. The information of touch position specification region information 63 is rewritten according to the selection of product B. That is, the touch position specification region ID associated with product A before the rewriting is rewritten to product B after the rewriting.

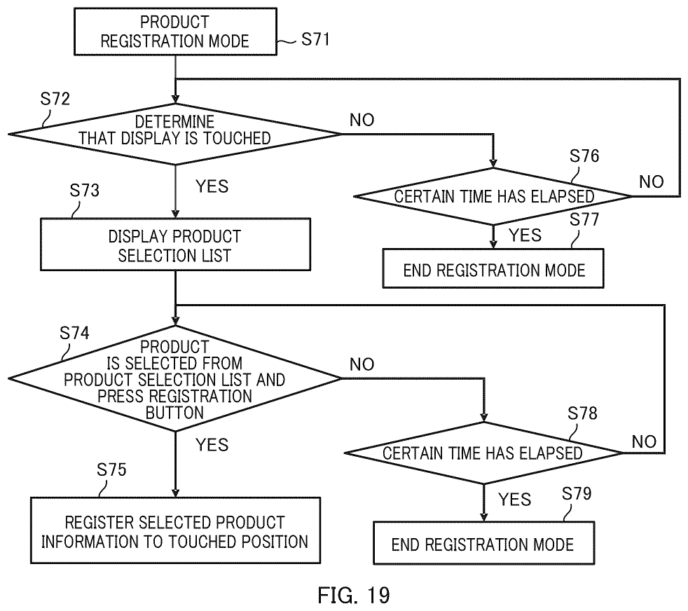

FIG. 19 is a flowchart illustrating a processing procedure in Variation 7 of Embodiment 1.

In Step S71, the display mode is switched to the product registration mode. The display is switched to the product registration mode by using the display controller or the physical button, the terminal, or the like of the store. As a result, the touch position specification region is displayed on the display, and the product replacement button is enabled.

In Step S72, it is determined that a touch via the product replacement button X is performed. When it is determined that a touch via the product replacement button X is performed, the processing proceeds to Step S73. When it is determined that a touch via the product replacement button is not performed, the processing proceeds to Step S76.

In Step S73, the product selection list is displayed. The product selection list is displayed according to the touched product replacement button X. The user is in a state of being able to select a new product from the list.

In Step S74, the product is selected from the product selection list, and the registration button is pressed. When the registration button is pressed, the processing proceeds to Step S75. When the registration button is not pressed, the processing proceeds to Step S78.

In Step S75, the selected product information is registered at the touched position.

In Step S76, when a certain time (a predetermined time) has elapsed, the processing proceeds to Step S77. When the certain time has not elapsed, the processing returns to Step S72.

In Step S77, the registration mode is ended. As a result, the button or the product list on the screen is not displayed.

In Step S78, when a certain time (a predetermined time) has elapsed, the processing proceeds to Step S79. When the certain time has not elapsed, the processing returns to Step S74.

In Step S79, the registration mode is ended. As a result, the button or the product list on the screen is not displayed.

According to Variation 7 of Embodiment 1, by using the product registration mode that enables efficient product replacement, the product displayed in the showcase can be quickly and accurately replaced with another product. As a result, the work time for product replacement is shortened, and the maintenance efficiency is improved. Furthermore, since the frequency of opening and closing the door and the opening time are suppressed and the inside temperature of the cold equipment such as the showcase in which the product is stored is suppressed from increasing, the energy saving performance can be improved.

Since a product can be selected by the touch operation via the intuitive interface (replacement button or product list displayed on the transmissive display), the operation is very intuitive, and it is not necessary to perform complicated settings, so that the work burden on the store staff is reduced.

The product information can be easily managed. By pressing the replacement button, the product list according to the category can be easily displayed, and the product can be selected. As a result, the product information in the showcase is always kept in the latest state, and accurate information can be provided to the customer. In the product registration mode, since the product name and/or the position of the button is clearly displayed on the display while the product behind is visually recognized, the visibility is high and an operation error is reduced. Since the touch position specification region for each product is set, the replacement operation can be accurately performed for each product. As a result, it is possible to replace only a specific product, and a partial change can be made without affecting other products.

As described above, since the work efficiency of the store staff is improved and accurate and up-to-date information can always be provided to the customer, the entire operation of the showcase or the product display is improved.

### Variation 8 of Embodiment 1: Registration of Product Using External Device

Variation 7 of Embodiment 1 is directed to an example of performing the product registration individually by an individual touch of the product list displayed on the screen. Variation 8 of Embodiment 1 is directed to an example of performing the product registration by using external device cooperator 35.

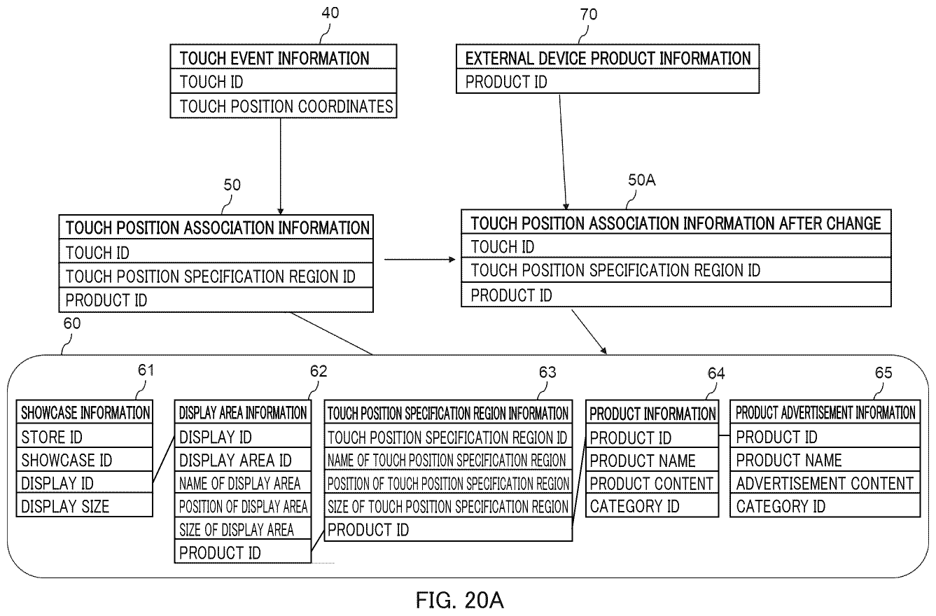

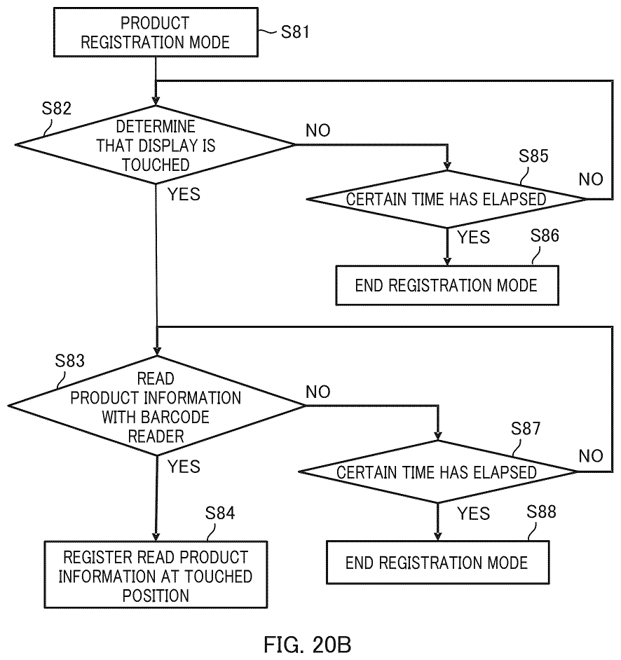

Variation 8 of Embodiment 1 will be described with reference to FIG. 20A. FIG. 20A is a diagram illustrating information used in performing the product registration by using external device cooperator 35.

### (Transition of Transmissive Display to Registration Mode of Product)

The switching from the transmissive mode, the advertisement mode, or the off mode to the product registration mode is performed by using, for example, the display controller or store terminal 4 installed in the store, a tablet or a smartphone, a physical button provided in the showcase, a menu button on the display, or the like.

### (Touch Position Manager 36)

Touch position manager 36 acquires touch event information 40 related to a touch event. “Touch event information 40” is provided as a database composed of, for example, as indicated in Table 15, a touch ID set to identify a touch event and position coordinates (x, y) on the touched screen.

TABLE 15

| | Touch position |
|---|---|
| Touch ID | coordinates (x, y) |
| Touch_1 | (100, 100) |

Touch position manager 36 generates touch position association information 50 that associates the touch position coordinates with the touch position specification region. Touch position association information 50 is composed of, for example, as indicated in Table 16, a touch ID, a touch position specification region ID, and a product ID.

TABLE 16

| | Touch position | |
|---|---|---|
| | specification | |
| Touch ID | region ID | Product ID |
| Touch_1 | Region_A | Product_X |

### (External Device Connector 35)

External device cooperator 35 is configured to read product information from an external device. The external device may be, for example, store terminal 4 as a barcode reader for reading a barcode attached to the product, or store terminal 4 for imaging the barcode attached to the product or reading a QR code (registered trademark) related to the product.

External device cooperator 35 receives touch position association information 50 from touch position manager 36 and starts a product registration process.

External device cooperator 35 reads external device product information 70 that is information on the product from store terminal 4 on which a read operation is performed by a user. “External device product information 70” includes, for example, a product ID as indicated in Table 17. External device product information 70 may include a product name and product information.

TABLE 17

Product ID
Product_Y

When receiving external device product information 70 from store terminal 4, external device cooperator 35 changes the product ID of touch position association information 50. That is, Product_X of touch position specification region A (Region_A) of touch position association information 50 is changed to Product_Y. Since changed touch position association information 50A in which the product ID is changed is associated with touch position specification region information 63, changing the product ID of touch position association information 50 to touch position association information 50A means changing the product ID in touch position specification region information 63. In registering a new product that is not registered in product information 64, external device cooperator 35 may be configured to read the product name, the product content, and the like in addition to the product ID from “external device product information 70” and register the new product.

### (Display Determiner 37)

Display determiner 37 may output a command to display the product name in all the touch position specification regions on the screen to transmissive touch display 11 and display 11 in order for the user to check whether the registration is appropriately performed. This entire display is executed, for example, when a user touches a product registration confirmation button. When the user presses the confirmation button, all the product names registered in the showcase are collectively displayed in the corresponding touch position specification region, so that it is possible to visually check on the display screen whether the registration is accurately performed. Furthermore, the entire display may be set to be displayed for a certain time and then automatically return to the non-display. During this time, the user can compare the displayed product name with the actual position of the product and immediately correct an error, if any. Further, after the user ends the confirmation work, the entire display can also be manually ended by touching a confirmation completion button.

FIG. 20B is a flowchart illustrating a processing procedure in Variation 8 of Embodiment 1. A processing flow of Variation 8 of Embodiment 1 will be described with reference to FIG. 20B.

In Step S81, the display mode is changed to the product registration mode.

In Step S82, it is determined whether transmissive touch display 11 is touched. This is determined by touch position manager 36 whether a touch event is present. When the presence of a touch is determined, the processing proceeds to Step S83. When the absence of a touch is determined, the processing proceeds to Step S85.

In Step S83, the user reads the product information by using am external device, such as a barcode reader. External device cooperator 35 reads the external device product information. When the reading event occurs, the processing proceeds to Step S84. When the reading event does not occur, the processing proceeds to Step S87.

In Step S84, the read product information is registered at the touched position. That is, external device cooperator 35 changes (registers for new registration) the product ID associated with the touch position specification region.

In Step S85, when a certain time has elapsed, the processing proceeds to Step S86. When the certain time has not elapsed, the processing returns to Step S81.

In Step S86, the registration mode is ended.

In Step S87, when a certain time has elapsed, the processing proceeds to Step S88. When the certain time has not elapsed, the processing returns to Step S83.

In Step S88, the registration mode is ended.

After Step S84, the product name may be displayed in all the touch position specification regions on the screen, and a confirmation step by the user may be provided.

According to Variation 8 of Embodiment 1, even when there are a large number of products, the time for the product registration work can be shortened as compared with a case of selecting a product from the product list, and the work efficiency can be improved. By using an external device (e.g., barcode reader or QR code reader), the product registration work is quickly and accurately performed. In particular, the fact that the information on a new product can be registered greatly improves the work efficiency. By reading the information from the external device through external device cooperator, the area that is touched is accurately associated with the product, and erroneous registration is prevented. Display determiner is equipped with a function of displaying all the registered product information, and the user can visually check the correct registration of the product. As a result, a registration error can be prevented in advance. Furthermore, since the frequency of opening and closing the door and the opening time are suppressed and the inside temperature of the cold equipment such as the showcase in which the product is stored is suppressed from increasing, the energy saving performance can be improved.

### Variation 9 of Embodiment 1: Product Registration Using Camera

Variation 9 of Embodiment 1 is directed to an example of imaging a product displayed in the showcase with a camera, specifying the product from the image, specifying the touch position specification region from the position of the product, and registering the specified product as a product associated with the specified touch position specification region. For example, a situation of performing product registration in making a large change in a large number of products in a product inventory situation is focused on.

### (Transition of Transmissive Display to Product Registration Mode)

The switching from any of the transmissive mode, the advertisement mode, or the off mode to the product registration mode is performed by using, for example, the display controller or store terminal 4 installed in the store, a tablet or a smartphone, a physical button provided in the showcase, the menu button on transmissive touch display 11 including the display, or the like.

### (External Camera)

A product in a state of being displayed in the showcase is imaged from the front of the showcase by using an external camera. The product package is disposed to face the front. This is because the product package is a key feature point for specifying the product. Further, an object that can be a reference, for example, the outer frame of the showcase or the outer frame of the display door including transmissive touch display 11 is also imaged. As a result, it is possible to ensure the position reference in the image analysis.

### (External Device Cooperator 35)

External device cooperator 35 receives the captured image from the external camera.

### (Image Recognizer 38)

Image recognizer 38 processes the captured image.

### (Specification of Product)

Image recognizer 38 detects the area of the product displayed in the showcase by using the image analysis algorithm. For example, the contour or the feature point of each product is specified by using an object detection technique. Examples of the feature point include a shape, a color, a logo, a package design, and characters (product name or brand name) of the product. These feature points are identified based on the pixel information in the image and are recognized as a unique pattern for each product. Further, an optical character recognition (OCR) technique may be used to recognize the product name or the description described on the product package and use the recognized information for the identification of the product.

Image recognizer 38 specifies the target product by collating the product image obtained from the captured image with the product image included in product information 64 for each feature point. The feature point extracted from the captured image is collated with the data included in product information 64. The match degree of each feature point is calculated. For example, when the average value of the match degrees of all the feature points is equal to or higher than a predetermined value (e.g., 80%), it is determined that the match is made. Further, since the text information is an important feature point in specifying the product, the text information may be weighted.

### (Specification of Center Position Coordinates of Product)

Image recognizer 38 obtains the center position coordinates of the product from the contour of the product. Image recognizer 38 detects the contour of the product by using, for example, an edge detection algorithm. The center position coordinate of the product is obtained from the extracted contour. The center position coordinates based on pixels on the screen are converted with reference to an object (outer frame of showcase or outer frame of door) that can be a reference.

### (Specification of Touch Position Specification Region)

### (Touch Position Manager 36)

Touch position manager 36 collates the center position coordinates based on pixels on the screen obtained by image recognizer 38 with the touch position specification region of touch position specification region information 63 to specify which touch position specification region the center position coordinates belong to.

### (Association Between Product and Touch Position Specification Region)

Touch position manager 36 generates product mapping information composed of the specified product and the specified touch position specification region. The product mapping information is, for example, as indicated in Table 18, the product ID and the product name of the specified product and the touch position specification region ID.

TABLE 18

| | | Touch position |
|---|---|---|
| | | specification |
| Product ID | Product name | region ID |
| Product_X | Product X | Region_A |
| Product_Y | Product Y | Region_B |
| Product_Z | Product Z | Region_C |

Touch position manager 36 changes the product ID and the touch position specification region ID of touch position specification region information 63 by using the product mapping information.

### (Display Determiner 37)

Display determiner 37 may output a command to display the product name in all the touch position specification regions on the screen to the display in order for the user to check whether the registration is appropriately performed. The entire display is executed, for example, when the user touches the product registration confirmation button. When the user presses the confirmation button, all the product names registered in the showcase are collectively displayed in the corresponding touch position specification region, and it is possible to visually check whether the registration is accurately performed. Furthermore, the entire display may be set to be displayed for a certain time and then automatically return to the non-display. During this time, the user can compare the displayed product name with the actual position of the product and individually correct an error, if any. Further, after the user ends the confirmation work, the entire display can also be manually ended by touching a confirmation completion button.

According to Variation 9 of Embodiment 1, since products are collectively imaged by using a camera and the products are automatically specified and associated with the touch position specification regions by the image analysis, the work efficiency in registering a large number of products at once is significantly improved. This is particularly useful at the time of inventory. By using the camera and the image recognition technology as compared with the manual registration work, it is possible to prevent the occurrence of human error. As a result, problems, such as erroneous registration of the product or omission of the information are reduced. Since the user can collectively display and check the registered product names on the screen by display determiner 37, the accuracy of the registration can be visually checked. Since an error can be corrected on the spot, the reliability of the registration work is improved. By the collective imaging with the camera and the automatic analysis, the entire registration work is simplified and the time is shortened. Since the individual registration by hand is not required, the efficiency of the store operation and the inventory management is improved. The process of the product registration is significantly improved in efficiency, and an erroneous registration and the burden of the confirmation work are reduced. Furthermore, since the frequency of opening and closing the door and the opening time are suppressed and the inside temperature of the cold equipment such as the showcase in which the product is stored is suppressed from increasing, the energy saving performance can be improved.

### Embodiment 2

In Embodiment 1, an aspect of specifying a touch position based on a touch sensor provided in transmissive touch display 11 has been described. The difference between Embodiment 2 and Embodiment 1 is that, first, in Embodiment 2, the present disclosure is applicable to an existing transparent touch display without providing a touch function display, second, in Embodiment 2, camera 13A for detecting a touch position is provided in showcase 10A, and third, in Embodiment 2, the touch position specification region for specifying the touch position is specified from an image captured by camera 13A. A description of the components having the same structure and function as those of Embodiment 1 will be omitted in some cases.

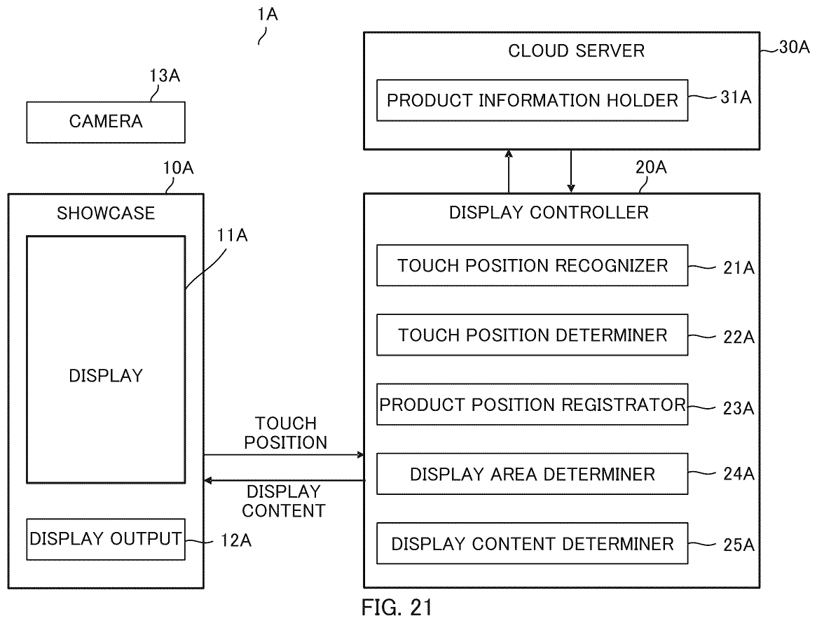

FIG. 21 is a diagram illustrating an overall configuration diagram of showcase system 1A according to Embodiment 2. As illustrated in FIG. 21, showcase system 1A includes showcase 10A, display controller 20A, cloud server 30A, and camera 13A. Display controller 20A and cloud server 30A are configured to perform display control of transmissive display 11A of showcase 10A, and can be regarded as a controller.

### (Showcase 10A)

Since showcase 10A is different from showcase 10 of Embodiment 1 in that showcase 10A includes transmissive display 11A and camera 13A, the difference will be described in detail, and a description of overlapping portions will be omitted.

### (Transmissive Display 11A)

Transmissive display 11A may be provided integrally with a door that opens and closes a customer retrieval type showcase in which a customer can select and take out a product by himself/herself. Further, transmissive display 11A may be provided as a front panel of a store clerk retrieval type showcase in which a customer does not directly touch a product and a store clerk takes out the product. Transmissive display 11A may not have a touch function. Since a camera that functions as a touch sensor or an image recognition technology is used as the touch sensor, it is possible to automatically detect the area touched by a user even when the user does not directly touch the product.

### (Camera 13A)

Camera 13A is provided to recognize an area of transmissive display 11A touched by the user. Camera 13A is installed, for example, on an upper part of transmissive display 11A and is disposed at a position where the movement of a finger of the user can be accurately captured. The installation position of camera 13A is set to a height and an angle at which the entirety of transmissive display 11A can be viewed, so that the touch operation over a wide range can be recognized with high accuracy regardless of the height or the standing position of the user.

Camera 13A may be installed on a lower part of transmissive display 11A. By installing camera 13A on a lower part of transmissive display 11A, the touch operation can be accurately captured from a position close to a hand of the user. In this disposition, camera 13A can easily track the movement of the hand or the touch position, and particularly, the recognition accuracy when the user touches the lower part can be improved.

Camera 13A may be installed on a side surface of transmissive display 11A. By installing cameras 13A on left and right side surfaces of transmissive display 11A and capturing the movement of a hand of the user laterally, the touch position is specified three-dimensionally. In this method, the entirety of transmissive display 11A can be covered, and particularly, high accuracy in recognizing a lateral movement can be provided. It is also possible to correct the perspective of the image by using both the left and right cameras 13A.

Cameras 13A may be installed on an upper part and a lower part. Cameras 13A are installed on an upper part and a lower part, and the touch position is three-dimensionally understood from two directions. As a result, the accuracy in touch recognition is further improved, and particularly, since the entirety of transmissive display 11A can be covered, it is possible to respond more flexibly to the operation of a user.

Camera 13A may be installed on a ceiling or at a position higher than showcase 10A. By installing the camera at a ceiling part away from showcase 10A or at a position higher than showcase 10A, transmissive display 11A can be imaged with a wide angle. In particular, this is effective when showcase 10A is large.

Camera 13A always images a surface of showcase 10A on which transmissive display 11A is provided. It is preferable that camera 13A determine an angle of view such that a frame of showcase 10A or a frame of a door is within an imaging range. These frames can be used to calculate coordinates as a reference in detecting the touch position, by recognizing these frames. Further, with reference to the frame, camera 13A can always understand the physical boundary of showcase 10A, and it is possible to ensure the consistency of long-term data.

### (Display Controller 20A)

Display controller 20A controls transmissive display 11A and determines content to be displayed on transmissive display 11A according to an image from camera 13A. Display controller 20A includes image recognizer 21A, touch position determiner 22A, product position registrator 23A, display area determiner 24A, and display content determiner 25A.

### (Image Recognizer 21A)

Image recognizer 21A recognizes, by using an image from camera 13A, touch-position coordinates (x, y) of a touch position at which a customer touched on a display screen (displayable area; hereinafter in Embodiment 2 simply referred to as “screen”) of transmissive display 11A. Image recognizer 21A is equipped with, for example, an image processing algorithm for processing in real time a video sent from camera 13A. The contour of the finger or the hand that is touched is recognized by using a contrast between transmissive display 11A and a background. Furthermore, the movement, the shape, and the position information of the finger are analyzed to accurately calculate the actual touch position coordinates (x, y). More specifically, in the video sent from camera 13A, an edge detection algorithm is applied to detect the contour of the hand or the finger of the user to specify a portion of transmissive display 11A where the finger is in contact.

Since camera 13A projects a 3D space onto a 2D space, a close object is large, and a distant object is small. When the perspective phenomenon affects the recognition of the touch position, a projective transformation or a perspective correction may be performed. For example, a projective transformation (homography transformation) may be applied to correct the distortion attributed to the perspective phenomenon. As a result, the video coordinates on the 2D image obtained from the viewpoint of the camera can be converted into screen coordinates of transmissive display 11A. Points are set at four corners or predetermined fixed positions of the frame of showcase 10A or transmissive display 11A, and the projective transformation can be performed with the coordinates of the points as a reference. As a result, it is possible to accurately correspond the coordinates on the camera video to the screen coordinates on transmissive display 11A.

As described above, image recognizer 21A recognizes the touch position coordinates (x, y) of the touch position on the screen of transmissive display 11A by a customer. It should be noted that a reference point and a unit of the touch position coordinates (x, y) can be optionally set, but it is preferable that the reference point of the touch position coordinates (x, y) be set to a reference point (generally, upper left corner) of the screen of transmissive display 11A and the unit be a pixel that is a unit of the size of the screen of transmissive display 11A. Since the consistency between the screen size and the touch position is ensured and the graphic elements (buttons, icons, sliders, and the like) are usually disposed in units of pixels, when the touch position is in units of pixels and the origin of the coordinate system matches, the touch operation and the coordinates of the graphical element can be directly matched. Furthermore, since the touch position in units of pixels completely matches the screen coordinate system, there is no need to convert the touch position into another coordinate system, and the complexity of data processing and coordinate calculation is reduced.

Image recognizer 21A can detect a line of sight of a person based on the image from camera 13A and determine whether the person is looking at transmissive display 11A. As the line-of-sight detection, for example, a face detection technique can be used. Camera 13A uses a face recognition technique to detect a person in front of transmissive display 11A, recognizes features of a face of the person in the image (relative positions of eyes, nose, and mouth, and the like), and specifies a position and an orientation of the face. For example, a face detection algorithm can be used. After the position of the face is specified, the focus is further placed on the eye area, and the position of a pupil is detected. This is performed by detecting a contour of an eye or a dark area of a pupil. When the position of a pupil is known, the direction of the line of sight can be estimated. For high-accuracy line-of-sight detection, a technique of using an infrared camera different from camera 13A to accurately detect the position of a pupil can also be used. After the position of a pupil is detected, the direction of the line of sight is estimated in combination with the orientation of the entire face. The direction of the line of sight can be calculated by using a relative positional relationship between the orientation of the face (horizontal and vertical angles) and the center position of the pupil. From this information, it is determined whether the user is looking at transmissive display 11A or facing another direction. Alternatively, the direction of the line of sight may be simply determined based on the orientation of the face of the person.

When image recognizer 21A determines that a person is not in front of transmissive display 11A, transmissive display 11A may erase the information displayed on transmissive display 11A.

### (Touch Position Determiner 22A)

Touch position determiner 22A determines, based on product position information held by product position registrator 23A, which area is touched by the touch position coordinates (x, y) on the screen obtained by image recognizer 21A. The product position information can be provided as a database having, for example, as indicated in Table 19, fields for a division region ID for uniquely identifying the division region, a division region name, a start position (x1, y1) and an end position (x2, y2) of the division region, a size of the division region, and a product ID for uniquely identifying the product.

TABLE 19

| | Name of | Start position (x1, y1) | Size of division | |
|---|---|---|---|---|
| Division | division | and end position (x2, y2) | region (width × | |
| region ID | region | of division region | height) | Product ID |
| Region_A | Division | (0, 0)~(500, 300) | 500 × 300 | Product_X |
| | region A | | | |
| Region_B | Division | (500, 0)~(1000, 300) | 500 × 300 | Product_Y |
| | region B | | | |
| Region_C | Division | (300, 300)~(800, 600) | 500 × 300 | Product_Z |
| | region C | | | |

Touch position determiner 22A determines which area the touch position coordinates (x, y) correspond to by using the product position information.

### (Product Position Registrator 23A)

Product position registrator 23A holds product position information on a position on the screen of transmissive display 11A corresponding to positions of a plurality of products displayed in showcase 10A. The product position information can be provided as a database as indicated in Table 19. In a case of describing the first row of Table 19, region A having Region A as a division region ID is defined by (0, 0) to (500, 300) as a start position (x1, y1) and an end position (x2, y2), has a size of 500×300 pixels, and indicates that product information having Product_A as a product ID is displayed at a predetermined position when the touch position coordinates (x, y) correspond to area A. The display area information held by display area determiner 24A is referred to in order to determine which position on the screen of transmissive display 11A the information on the product is displayed.

The numerical values of Table 19 are merely exemplary. As indicated in Table 19, the sizes of the division regions may not be the same. The number, the size, and the shape of the division regions can be flexibly changed according to a display layout of a plurality of products actually displayed in showcase 10A or a shape of the product, and an optimal division can be selected according to an actual use environment.

### (Display Area Determiner 24A)

Display area determiner 24A holds display area information on which position on the screen of transmissive display 11A the information on the product is displayed.

TABLE 20

| | | Start position (x1, y1) | | |
|---|---|---|---|---|
| Display | Name of | and end position (x2, y2) | Size of display area | |
| area ID | display area | of display area | (width × height) | Product ID |
| DisplayArea_1 | Display area 1 | (100, 200)~(600, 700) | 500 × 500 | Product_Z |
| DisplayArea_2 | Display area 2 | (400, 150)~(900, 650) | 500 × 500 | Product_Y |
| DisplayArea_3 | Display area 3 | (50, 100)~(550, 600) | 500 × 500 | Product_X |

The display area information is provided by a database having, for example, as indicated in Table 20, a display area for identifying a display area for displaying a product identified by a product ID, a display area name, a start position (x1, y1) and an end position (x2, y2) of the display area, a size (width×height) of the display area, and a product ID for uniquely identifying the product.

In a case of describing the first row of Table 20, display area 1 having DisplayArea_1 as a display area ID is defined by (100, 200) to (600, 700) as a start position (x1, y1) and an end position (x2, y2), has a size of 500×500 pixels, and indicates that product information having Product_Z as a product ID is displayed in area 1.

The numerical values of Table 20 are merely exemplary. As indicated in Table 20, the sizes of the display areas may not be the same. The display area can be flexibly set according to characteristics of transmissive display 11A, a size of information on the product, or a size of the advertisement. For example, when the product is vertically long, it is desirable that an area for displaying the product information is set to be wide in the vertical direction. In this case, the start position and the end position of the display area are determined in consideration of an aspect ratio of the product itself or a display area of the entire display screen of transmissive display 11A. Further, the display area can be set such that important information (price, features, and the like) of the product is disposed at a position that maximizes the visibility of the user. For example, when the product is displayed near the center of transmissive display 11A, the information on the product is not excessively biased to the upper or lower part of the screen and is disposed in a balanced manner. Therefore, display area determiner 24A may have an algorithm for automatically setting a position and a size suitable for each product. Furthermore, the setting of the display area may be dynamically changed in response to an external event as in Embodiment 1. In particular, when a plurality of products is displayed at the same time and the user taps a plurality of products, the display area on transmissive display 11A can be appropriately divided for each product, and each product information can be adjusted not to overlap.

Since the product position information of Table 19 and the display area information of Table 20 are associated with each other by the product ID, for example, when the touch position is in division region C, product information on a product having Product_Z as a product ID is displayed. Then, since the display area having Product_Z as a product ID in Table 20 corresponds to display area 1, the product information on the product having Product_Z as a product ID is displayed in display area 1.

### (Display Content Determiner 25A)

Display content determiner 25A has association information that associates the product position information, the display area information, and the product advertisement information, which is intermediate information of the three pieces of information. These three pieces of information are associated with each other via a product ID in common.

TABLE 21

| Division | Name of | Display | Name of | | Product |
|---|---|---|---|---|---|
| region ID | Division region | area ID | display area | Product ID | information |
| Region_A | Division | DisplayArea_3 | Display area 3 | Product_X | Description of |
| | region A | | | | Product X |
| Region_B | Division | DisplayArea_2 | Display area 2 | Product_Y | Description of |
| | region B | | | | Product Y |
| Region_C | Division | DisplayArea_1 | Display area 1 | Product_Z | Description of |
| | region C | | | | Product Z |

The association information is provided by a database having, for example, a division region ID, a division region name, a display area ID, a display area name, a product ID, and product information.

In a case of describing the first row of Table 21, when the touch position coordinates (x, y) are in division region A, product information X of the product is displayed in display area 3 on the screen.

Display content determiner 25A outputs an instruction to display the information on the product in the display area according to the location where the touch position coordinates (x, y) are detected, based on the association information to the display unit of transmissive display 11A.

### (Cloud Server 30A)

Cloud server 30A is connected to display controller 20A by radio. Cloud server 30A includes product information holder 31A.

### (Product Information Holder 31A)

Product information holder 31A holds product information related to a product and an advertisement. The product information has, for example, a product ID and product advertisement information as indicated in Table 3.

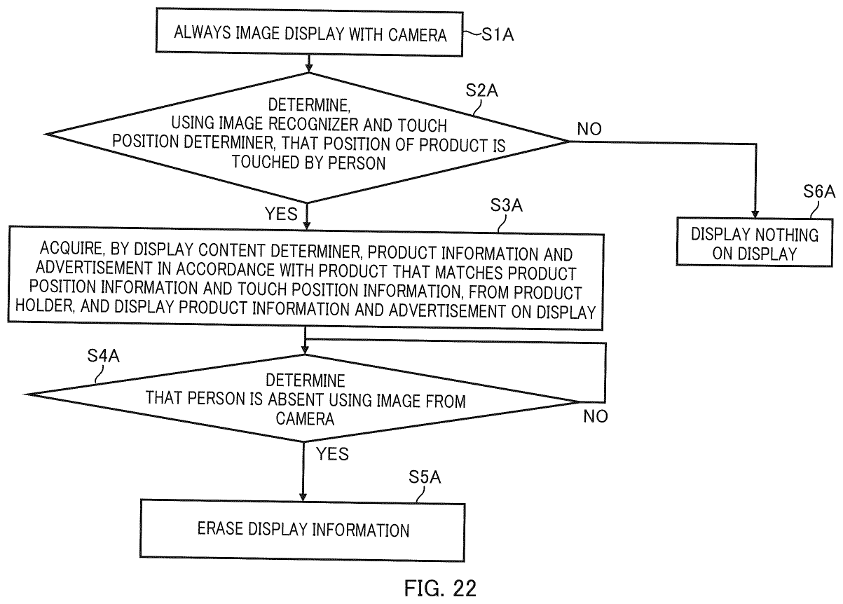

FIG. 22 is a flowchart illustrating a processing procedure in Embodiment 2. The processing procedure of showcase system 1A will be described with reference to FIG. 22.

In Step S1A, camera 13A provided in showcase 10A starts always imaging transmissive display 11A.

In Step S2A, image recognizer 21A recognizes the touch position coordinates (x, y) of the touch position on the screen of transmissive display 11A by a customer, by using the image from camera 13A. Further, touch position determiner 22A determines, based on the product position information held by product position registrator 23A, which area is touched by the touch position coordinates (x, y) on the screen obtained by image recognizer 21A. When touch position determiner 22A appropriately determines the touch position in Step S2A, the processing proceeds to Step S3A. When touch position determiner 22A cannot appropriately determine the touch position in Step S2A, the processing proceeds to Step S4A.

In Step S3A, display content determiner 25A outputs an instruction to display the information on the product in the display area according to the location where the touch position coordinates (x, y) are detected, based on the association information to display output 12A of transmissive display 11A.

In Step S4A, when image recognizer 21A determines that there is no person based on the image from camera 13A, the processing proceeds to Step S6A. When it is determined that there is a person, Step S4A is repeated.

In Step S5A, the information displayed on the display is erased.

In Step S6A, nothing is displayed on the display.

According to showcase system 1A of Embodiment 2, transmissive display 11A without a touch function can be supported. It is not necessary to install a display with a touch function, and the present disclosure can be applied to an existing transmissive display. As a result, since the touch position can be detected by using the camera or the image recognition technology without modifying the existing display, the introduction cost can be significantly reduced.

Further, the touch position can be detected with high accuracy by camera 13A. By detecting the touch position by using camera 13A, the touch operation over a wide range can be recognized with high accuracy regardless of the height or the standing position of the user. In particular, the touch position can be detected in more detail by the installation position of the camera or the three-dimensional recognition by a plurality of cameras.

Furthermore, it also contributes to improving hygiene by non-contact operation. In Embodiment 2, since the touch position can be detected without the user directly touching the display, a non-contact interface can be provided. As a result, in a public place or a store where many people are likely to touch, the risk in terms of hygiene is reduced, and the users are given a sense of security.

Furthermore, an energy saving effect is obtained by the line-of-sight detection function. When the customer is not looking at transmissive display 11A or there is no person in front of transmissive display 11A, the information on display 11A can be erased. By the line-of-sight detection function, unnecessary display can be avoided and power consumption can be suppressed, so that it is possible to perform environmentally friendly operation.

Furthermore, showcase system 1A of Embodiment 2 has wide adaptability. In Embodiment 2, various showcases equipped with transmissive display 11A can be supported, and an environment in which customers can check products without touching the products can be provided. As a result, a highly versatile system that can be used for both store clerk retrieval type and customer retrieval type showcases is obtained.

As described above, according to Embodiment 2, it is possible to provide advantages such as cost reduction, high-accuracy operation detection, improvement in hygiene, and an energy saving effect. Furthermore, since the frequency of opening and closing the door and the opening time are suppressed and the inside temperature of the cold equipment such as the showcase in which the product is stored is suppressed from increasing, the energy saving performance can be improved.

### Variation 1 of Embodiment 2

Variation 1 of Embodiment 2 will be described. Variation 1 of Embodiment 2 relates to the sizes of the division regions indicated in Table 19. According to Variation 1 of Embodiment 2, the sizes of the division regions are set based on the ability of camera 13A and image recognizer 21A.

Here, the “ability of camera 13A” refers to a resolution, an angle of view, and a frame rate of an image that can be acquired by the camera. The higher the ability, the more accurately the area on the display can be imaged, and the touch position or the operation of the user can be detected with high accuracy. “Ability of image recognizer 21A” refers to a processing speed of analyzing image data acquired from camera 13A, a recognition accuracy of an object (e.g., finger or hand), and a determination ability of the touch position. The higher the processing ability of image recognizer 21A, the more accurately the touch can be detected even in a smaller division region. On the contrary, when the recognition accuracy is low, it is necessary to increase the size of the division region to prevent misrecognition. As described above, the size of the optimal division region is determined based on the ability of camera 13A and image recognizer 21A.

### Variation 2 of Embodiment 2

Variation 2 of Embodiment 2 will be described. Variation 2 of Embodiment 2 relates to a case where the product advertisement information indicated in Table 3 has hierarchical information composed of first product advertisement information, second product advertisement information, and third product advertisement information. The first product advertisement information of the first hierarchy is, for example, a portion in which general information on the product or a basic advertisement is displayed. The second product advertisement information of the second hierarchy is information that can be transitioned from the first hierarchy by a touch operation or the like on the screen when the user is interested in the information displayed in the first product advertisement information and hopes to know more detailed information. In the second product advertisement information of the second hierarchy, deeper information such as detailed specifications, function descriptions, and usage methods of the product is provided. The third product advertisement information of the third hierarchy is information that can be accessed by the user from the second hierarchy when the user wants to further check the second product advertisement information of the second hierarchy. The third product advertisement information of the third hierarchy displays content related to more specialized information or user support. For example, the third product advertisement information of the third hierarchy includes guarantee information of the product, technical specifications, guidance to a support window, or user reviews and Q&A.

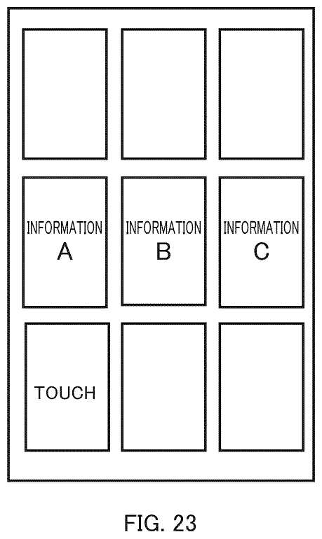

FIG. 23 is a diagram illustrating a display example of first product advertisement information A of the first hierarchy, second product advertisement information B of the second hierarchy, and third product advertisement information C of the third hierarchy. In a case of displaying such hierarchical information, display areas can be assigned such that the first product advertisement information of the first hierarchy, the second product advertisement information of the second hierarchy, and the third product advertisement information of the third hierarchy do not overlap.

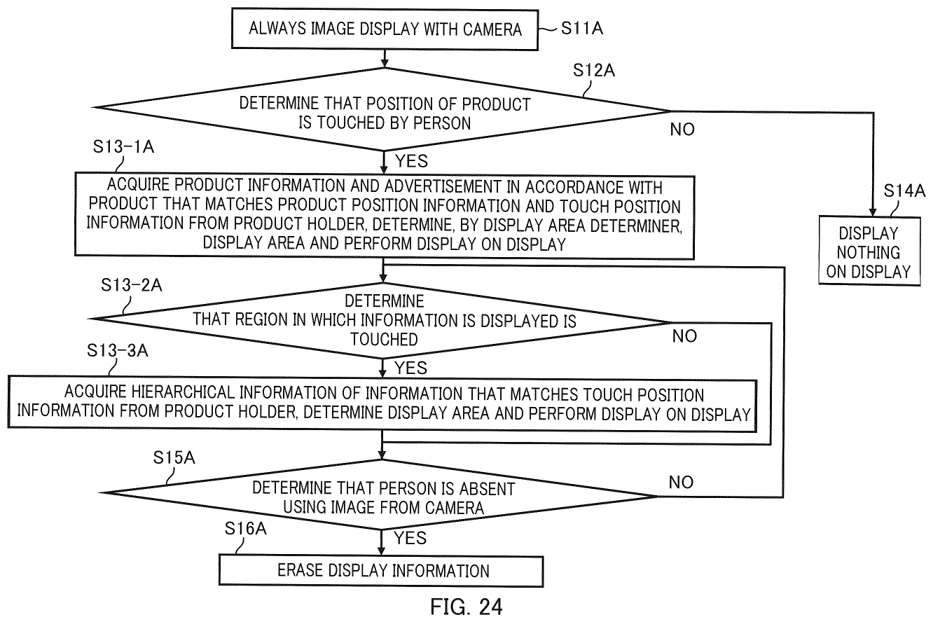

FIG. 24 is a flowchart illustrating a processing procedure of Variation 2 of Embodiment 2.

In Step S11A, the display is always imaged by the camera. The image acquired by the camera is used to accurately determine the touch position on the display.

In Step S12A, image recognizer 21A and touch position determiner 22A determine whether a person has touched the position of the product. When it is determined that the touch is performed, the processing proceeds to Step S13-1A. When it is not determined that the touch is performed, the processing proceeds to Step S14A.

In Step S13-1A, display content determiner 25A acquires product information and an advertisement corresponding to the product that matches the product position information and the touch position information from product information holder 31A, and display area determiner 24A determines the display area and displays the product information and the advertisement on transmissive display 11A.

In Step S13-2A, it is determined whether an area in which the information is displayed is touched. When it is determined that the touch is performed, the processing proceeds to Step S13-3A. When it is not determined that the touch is performed, the processing proceeds to Step S15A.

In Step S13-3A, display content determiner 25A acquires hierarchical information of the information that matches the touch position information from product information holder 31A, and display area determiner 24A determines the display area and displays the information on transmissive display 11A.

In Step S14A, nothing is displayed on transmissive display 11A.

In Step S15A, image recognizer 21A determines whether there is a person from the image from the camera. When it is determined that there is a person, the processing returns to Step S13-2A. When it is determined that there is no person, the processing proceeds to Step S16A.

In Step S16A, the information on transmissive display 11A is erased.

According to Variation 2 of Embodiment 2, the user experience can be improved by providing the hierarchical information. In Variation 2 of Embodiment 2, the hierarchical information display is adopted. In the first hierarchy, basic information on the product is provided, and when the user is further interested, the user can obtain more detailed and specialized information via transition to the second and third hierarchies. With this mechanism, since the user can acquire information in stages according to the interest, the user experience can be improved without displaying excessive information at once. Further, since the user can efficiently access the necessary information, the user satisfaction is improved.

The efficiency of the information display is improved. Since different information is displayed for each hierarchy, it is possible to avoid unnecessary display of detailed information or specialized information for the user who is not interested in the product in the first hierarchy. As described above, by displaying the information in a stepwise manner, the information display on the display is improved in efficiency. As a result, the load on the display is reduced, and unnecessary resource consumption can be suppressed.

The display area can be optimally assigned. Since the display area is assigned such that the information of each hierarchy does not overlap, the displayed information is visually organized, and it is easy for the users to see. Further, by displaying different information for each hierarchy, a limited display area can be effectively used. As a result, the users can smoothly access the necessary information and can perform an intuitive operation.

An energy saving effect is obtained. In the above-described Step S14A or S16A, a state in which nothing is displayed on the display or a state in which the information is erased is realized. With this function, when there is no user or unnecessary information is not displayed, the energy consumption of the display is suppressed, and an energy saving effect is obtained. As a result, the energy efficiency of the entire system is improved.

As described above, according to Variation 2 of Embodiment 2, technical effects such as the provision of hierarchical information, the efficiency of the information display, the improvement in interaction, and the improvement in energy efficiency are obtained. As a result, the convenience of users is improved, and the operation efficiency of the entire system is improved.

### Variation 3 of Embodiment 2

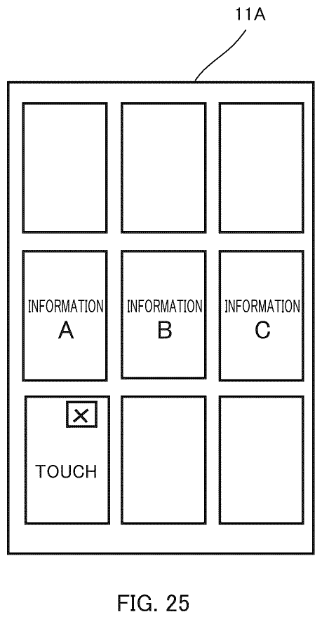

Variation 3 of Embodiment 2 will be described. Variation 3 relates to a method of returning to an initial state in a state where the product advertisement information is displayed on the screen of transmissive display 11A by touching the screen. Here, the “initial state” refers to a state in which no information is displayed on the screen. As illustrated in FIG. 25, in Variation 3, a close button for closing, by the user, the product advertisement information displayed in the display area without displaying the product advertisement information in the division region corresponding to the touch position is configured to be displayed. When the user presses the close button, the product advertisement information displayed in the display area is erased. By disposing the close button, it is possible to reduce the time and effort required for users to search for the close button when users hope to close the information and return to the initial state. Further, since the position is the first position to be touched, the close button can be pressed regardless of the height or the like.

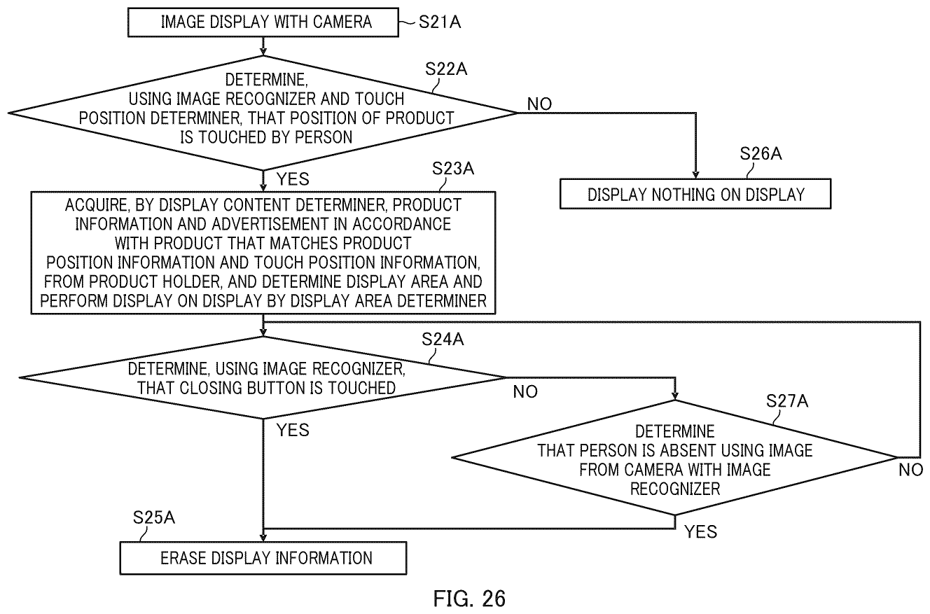

FIG. 26 is a flowchart illustrating a processing procedure of Variation 3 of Embodiment 2.

In Step S21A, camera 13A images the screen of transmissive display 11A.

In Step S22A, image recognizer 21A and touch position determiner 22A determine that a person has touched the position of the product. When it is determined that the touch is performed, the processing proceeds to Step S23A, and when it is not determined that the touch is performed, the processing proceeds to Step S26A.

In Step S23A, display content determiner 25A acquires product information and an advertisement corresponding to the product that matches the product position information and the touch position information from product information holder 31A, and display area determiner 24A determines the display area and displays the product information and the advertisement on transmissive display 11A.

In Step S24A, image recognizer 21A determines that the close button is touched. When it is determined that the touch is performed, the processing proceeds to Step S25A, and when it is not determined that the touch is performed, the processing proceeds to Step S27A.

In Step S25A, the information on transmissive display 11A is erased.

In Step S26A, nothing is displayed on transmissive display 11A.

In Step S27A, image recognizer 21A determines that there is no person from the image from camera 13A. When it is determined that there is no person, the processing proceeds to Step S25A. When it is determined that there is a person, the processing proceeds to Step S24A.

According to Variation 3 of Embodiment 2, it is possible to quickly return to the initial state. The users can immediately erase the information and return transmissive display 11A to the initial state (state in which nothing is displayed) by touching the “close button” for closing the product advertisement information displayed on transmissive display 11A. As a result, the user can quickly remove unnecessary information from the visual field. By displaying the “close button” at the position first touched by the user, the user can easily operate the button regardless of the height of the user or the reach of hand. As a result, the user does not need to look for the close button by deliberately viewing the entire transmissive display 11A. Since the close button is directly displayed at the touched position, the risk of the user touching an unintended position is reduced. As a result, the accuracy of the operation is improved. By automatically displaying the close button at the touch position, an interface that is easy to use for anyone regardless of the height or the operation ability is provided. Therefore, the stress on the operation of users is reduced, and the operation feeling is improved. Since the information or the close button is displayed according to the touch position, the display area of transmissive display 11A can be efficiently used, and the information can be provided to the user in an easily visible manner.

In the above-described embodiments, the term “section” or “unit” or “-er or -or”, used for each component may be replaced with other terms, such as “circuit (circuitry)”, “assembly”, “device”, “unit”, or “module”.

The configurations illustrated in the above-described embodiments are merely examples, and can be combined with another known technology, can be combined with each other, or can be omitted or changed in a part of the configuration within a range not departing from the gist.

While various embodiments have been described herein above, it is to be appreciated that various changes in form and detail may be made without departing from the spirit and scope of the invention(s) presently or hereafter claimed.

This application is entitled to and claims the benefit of Japanese Patent Application No. 2024-230243, filed on Dec. 26, 2024, the disclosure of which including the specification, drawings and abstract is incorporated herein by reference in its entirety.

### INDUSTRIAL APPLICABILITY

One example of the present disclosure is useful for showcases.

1. A showcase capable of storing a product, the showcase comprising:
a display screen disposed such that the product is visible;
a touch position detection device configured to detect a touch position on the display screen; and
a controller configured to display, on the display screen, product information related to the product associated with the touch position, in accordance with the touch position.

2. The showcase according to claim 1, wherein,
the association between the touch position and the product is performed based on a touch position specification region on the display screen, and
the touch position specification region is a region set by dividing the display screen into a plurality of areas in accordance with the product.

3. The showcase according to claim 2, wherein, a position of a display area of the product information is set to be separate from the touch position specification region in which the touch position has been detected.

4. The showcase according to claim 1, wherein,
the association between the touch position and the product is performed based on a touch position specification region on the display screen, and
a display area associated with the product is set outside the touch position specification region.

5. The showcase according to claim 3, further comprising a sensor capable of detecting a person, wherein, the controller is configured to change, when the person touches the display screen, a position of the display area on the display screen in accordance with a height of the person detected by the sensor.

6. The showcase according to claim 2, wherein, the controller is configured to correct the touch position specification region based on a position of a person who has touched the display screen and a touch position on the display screen.

7. The showcase according to claim 1, further comprising a sensor capable of detecting a person, wherein, the controller is configured to set an advertisement mode in which the product information is displayed on an entirety of the display screen, when determining that a person is present within a range of a first predetermined distance from the showcase.

8. The showcase according to claim 7, wherein,
the controller is configured to change the advertisement mode to a transmissive mode when determining that a person is present within a range of a second predetermined distance which is a distance closer to the showcase than the first predetermined distance is, and
the transmissive mode is a display mode in which the product is visible from outside and the touch position detection device is in a state of being capable of detecting a touch event.

9. The showcase according to claim 1, wherein,
the display screen is a transmittance controllable display screen, and
the controller is configured to perform switching of a display mode of the display screen, and
the switching of the display mode is performed between a transmissive mode in which the product is visible from outside and the touch position detection device is in a state of being capable of detecting a touch event; an advertisement mode in which the product information is displayed on an entirety of the display screen; and a power source off mode in which the product is visible from outside and the touch position detection device is not in a state of being capable of detecting a touch event.

10. The showcase according to claim 9, wherein, the switching of the display mode is performed based on at least one of a gaze duration of the person toward the display screen, a gaze frequency of the person toward the display screen, a stagnation time of the person, an approaching speed of the person, a movement direction of the person, and/or a change in facial expression of the person.

11. The showcase according to claim 9, wherein, the switching of the display mode is performed based on at least one of a gaze duration of a person closest to the showcase with respect to the display screen, a gaze frequency of a person closest to the showcase with respect to the display screen, a stagnation time of a person closest to the showcase, an approaching speed of a person closest to the showcase, a movement direction of a person closest to the showcase, and/or a change in facial expression of a person closest to the showcase among a plurality of persons.

12. The showcase according to claim 3, wherein, a size of the display area is set in accordance with a number of touches by a user.
